(19) United States
(12) Patent Application Publication
(10) Pub. No.: US 2025/0219309 A1
(43) Pub. Date: Jul. 3, 2025

(54) ELECTRICAL CONNECTOR PAIR

(71) Applicant: I-PEX Inc., Kyoto-shi (JP)

(72) Inventors: Yuki MIYAZAKI, Ogori-shi (JP); Tadamichi YAYOSHI, Machida-shi (JP); Takashi MASUNAGA, Ogori-shi (JP)

(21) Appl. No.: 18/979,386

(22) Filed: Dec. 12, 2024

Related U.S. Application Data
(63) Continuation of application No. 17/782,965, filed on Jun. 6, 2022, now Pat. No. 12,218,446.

(30) Foreign Application Priority Data
Dec. 9, 2019 (JP) 2019-222381

(51) Int. Cl. H01R 12/71; H01R 13/516; H01R 13/6471

(52) U.S. Cl. CPC H01R 12/716; H01R 13/516; H01R 13/6471

(57) ABSTRACT

An electrical connector pair includes a receptacle connector and a plug connector. The receptacle connector includes a first partition wall, and the plug connector includes a second partition wall. When the receptacle connector and the plug connector are fitted together, the first partition wall partitions a portion of the boundary between a third holder and a fourth holder where the second partition wall is not formed such that a first contact and a third contact cannot be seen from a second contact and a fourth contact.

### CROSS-REFERENCE TO RELATED APPLICATIONS

This is a continuation of U.S. patent application Ser. No. 17/782,965, filed Jun. 6, 2022, which is a national phase application of International Patent Application No. PCT/JP2020/044603, filed Dec. 1, 2020, which claims priority to JP Patent Application No. 2019-222381, filed Dec. 9, 2019, the disclosures of which are hereby incorporated by reference in their entirety.

### TECHNICAL FIELD

The present disclosure relates to an electrical connector pair.

### BACKGROUND ART

Patent Literature 1 describes a connector provided with a noise countermeasure. A metal conductive member (shield member) is mounted on an outer peripheral surface of the connector. As a result, the connector reduces noise.

### CITATION LIST

### Patent Literature

Patent Literature 1: International Publication No. WO 2015/045623.

### SUMMARY OF INVENTION

### Technical Problem

Increases in the communication speeds of signals in recent years have led to a need for further noise countermeasures. This is because, when the communication speed of a signal increases, the noise emitted from one of the transmission lines that transmits the signal is introduced into another transmission line that transmits the signal, and electric coupling of the two transmission lines may increase.

In light of this problem, an object of the present disclosure is to provide an electrical connector pair that is capable of reducing the noise that is introduced into the transmission lines of a signal.

### Solution to Problem

An electrical connector pair according to a first aspect of the present disclosure that achieves the objective described above is an electrical connector pair including a first connector mounted on a first substrate; and a second connector mounted on a second substrate, wherein the first connector includes an electrically conductive first contact that connects to a signal electrode of the first substrate, an electrically conductive second contact that connects to the signal electrode of the first substrate, an electrically conductive first periphery surrounding wall that, when viewed from a direction normal to a main surface of the first substrate, is arranged so as to surround the first contact and the second contact, and that connects to a ground electrode of the first substrate, an insulating first housing that includes a first holder that insulates and holds the first contact and the first periphery surrounding wall, and a second holder that insulates and holds the second contact and the first periphery surrounding wall, and an electrically conductive first partition wall that is held by the first housing so as to partition a portion of a boundary between the first holder and the second holder in a state insulated from the first contact and the second contact, and that is grounded to the first substrate, the second connector includes an electrically conductive third contact that connects to a signal electrode of the second substrate, and that contacts the first contact when the first connector and the second connector are fitted together, an electrically conductive fourth contact that connects to the signal electrode of the second substrate, and that contacts the second contact when the first connector and the second connector are fitted together, an electrically conductive second periphery surrounding wall that, when viewed from a direction normal to a main surface of the second substrate, is arranged so as to surround the third contact and the fourth contact, and that connects to a ground electrode of the second substrate, an insulating second housing that includes a third holder that insulates and holds the third contact and the second periphery surrounding wall, and a fourth holder that insulates and holds the fourth contact and the second periphery surrounding wall, and an electrically conductive second partition wall that is held by the second housing so as to partition a portion of a boundary between the third holder and the fourth holder in a state insulated from the third contact and the fourth contact, and that is grounded to the second substrate, and when the first connector and the second connector are fitted together, the first partition wall partitions a portion of boundary between the third holder and the fourth holder where the second partition wall is not formed, such that the first contact and the third contact cannot be seen from the second contact and the fourth contact.

A configuration is possible in which the first partition wall includes a first end that contacts the first substrate, and a first ground connector that connects to the ground electrode of the first substrate is provided on the first end.

A configuration is possible in which the second partition wall includes a second end that contacts the second substrate, and a second ground connector that connects to the ground electrode of the second substrate is provided on the second end.

A configuration is possible in which, in the first connector, the first partition wall is arranged such that the first contact cannot be seen from the second contact, and in the second connector, the second partition wall is arranged such that the third contact cannot be seen from the fourth contact.

A configuration is possible in which the first partition wall and the second partition wall contact each other when the first connector and the second connector are fitted together.

A configuration is possible in which the first partition wall and the second partition wall engage with each other when the first connector and the second connector are fitted together.

A configuration is possible in which, when the first connector and the second connector are fitted together, the second partition wall is arranged so as to overlap the first partition wall when viewing from the first contact and the third contact.

A configuration is possible in which, when the first connector and the second connector are fitted together, the first, second, third, and fourth contacts are doubly surrounded by the first periphery surrounding wall and the second periphery surrounding wall.

A configuration is possible in which the first periphery surrounding wall and the second periphery surrounding wall engage with each other when the first connector and the second connector are fitted together.

A configuration is possible in which an electrically conductive first coupler is provided that couples the first partition wall and the first periphery surrounding wall, and an electrically conductive second coupler is provided that couples the second partition wall and the second periphery surrounding wall.

A configuration is possible in which the first coupler is a plate-like member that intersects a line normal to the main surface of the first substrate, and the second coupler is a plate-like member that intersects a line normal to the main surface of the second substrate.

A configuration is possible in which an annular protrusion is formed, by the first partition wall, the first periphery surrounding wall, and the first coupler, that surrounds the first contact, and a recess is formed, by the second partition wall, the second periphery surrounding wall, and the second coupler, that surrounds the second contact, and into which the protrusion fits when the first connector and the second connector are fitted together.

A configuration is possible in which, in the first connector, a pair of the first holder is arranged so as to sandwich the second holder, and in the second connector, a pair of the third holder is arranged so as to sandwich the fourth holder.

### Advantageous Effects of Invention

With the electrical connector pair according to the present disclosure, the first connector includes the electrically conductive first partition wall that partitions the first contact and the second contact, and the second connector includes the electrically conductive second partition wall that partitions the third contact and the fourth contact. When the first connector and the second connector are fitted together, the first partition wall partitions the portion of boundary between the third holder and the fourth holder where the second partition wall is not formed, such that first contact and the third contact cannot be seen from second contact and the fourth contact. With such a configuration, the first partition wall and the second partition wall complement each other and, thereby, can block electromagnetic waves that radiate from the second and fourth contacts or the first and third contacts. As a result, the noise that is introduced into the transmission lines of the signal can be reduced.

### BRIEF DESCRIPTION OF DRAWINGS

FIG. 1A is a perspective view of a receptacle connector of an electrical connector pair according to Embodiment 1 of the present disclosure;

FIG. 1B is a perspective view of a plug connector of the electrical connector pair according to Embodiment 1 of the present disclosure;

FIG. 2A is a top view of the receptacle connector of FIG. 1A;

FIG. 2B is a bottom view of the receptacle connector of FIG. 1A;

FIG. 3A is a perspective view illustrating a first contact;

FIG. 3B is a first side view illustrating the first contact;

FIG. 3C is a top view illustrating the first contact;

FIG. 3D is a second side view illustrating the first contact;

FIG. 4 is a perspective view illustrating the configuration of the receptacle connector, in which portions formed by electrically conductive members are extracted;

FIG. 5 is a cross-sectional view taken along line A-A of FIG. 2A;

FIG. 6 is a drawing illustrating the arrangement of a signal electrode and a ground electrode on a first substrate;

FIG. 7A is a top view of the plug connector of FIG. 1B;

FIG. 7B is a bottom view of the plug connector of FIG. 1B;

FIG. 8A is a perspective view illustrating a third contact;

FIG. 8B is a first side view illustrating the third contact;

FIG. 8C is a top view illustrating the third contact;

FIG. 8D is a second side view illustrating the third contact;

FIG. 9 is a perspective view illustrating the configuration of the receptacle connector, in which portions formed by electrically conductive members are extracted;

FIG. 10 is a cross-sectional view taken along line B-B of FIG. 7A;

FIG. 11 is a drawing illustrating the arrangement of the signal electrode and the ground electrode on a second substrate;

FIG. 12 is perspective cross-sectional view taken along line A-A and line B-B, immediately before fitting the receptacle connector and the plug connector together;

FIG. 13 is cross-sectional view taken along line A-A and line B-B, immediately before fitting the receptacle connector and the plug connector together;

FIG. 14 is drawing of when the receptacle connector and the plug connector are fitted together;

FIG. 15 is a side view of when the receptacle connector and the plug connector are fitted together;

FIG. 16 is a schematic view illustrating the surroundings of first contact and the third contact, in a state in which the first contact and the third contact are fitted together;

FIG. 17 is a perspective view illustrating the configuration of a plug connector of an electrical connector pair according to Embodiment 2 of the present disclosure;

FIG. 18 is a perspective view of portions of the plug connector of FIG. 17 that are formed by electrically conductive members;

FIG. 19 is a cross-sectional view taken along line C-C of FIG. 17, of when the receptacle connector and the plug connector are fitted together;

FIG. 20 is a schematic drawing illustrating a modified example of a first partition wall and a second partition wall of an electrical connector pair according to Embodiment 3 of the present disclosure;

FIG. 21A is a perspective view illustrating the configuration of a receptacle connector of an electrical connector pair according to Embodiment 4 of the present disclosure;

FIG. 21B is a perspective view illustrating the configuration of a plug connector of the electrical connector pair according to Embodiment 4 of the present disclosure;

FIG. 22A is a side view illustrating a first contact;

FIG. 22B is a side view illustrating a second contact;

FIG. 23A is a perspective view illustrating the configuration of the receptacle connector in which portions formed by electrically conductive members are extracted;

FIG. 23B is a perspective view illustrating the configuration of the plug connector, in which portions formed by electrically conductive members are extracted;

FIG. 24A is a cross-sectional view taken along line D-D of FIG. 21A, and a cross-sectional view taken along line E-E of FIG. 21B, of a state in which the receptacle connector and the plug connector are made to face each other;

FIG. 24B is a cross-sectional view taken along line D-D of FIG. 21A, and a cross-sectional view taken along line E-E of FIG. 21B, of a state in which the receptacle connector and the plug connector are fitted together;

FIG. 25A is a perspective view illustrating the configuration of a receptacle connector of an electrical connector pair according to Embodiment 5 of the present disclosure;

FIG. 25B is a perspective view illustrating the configuration of a plug connector of the electrical connector pair according to Embodiment 5 of the present disclosure;

FIG. 26A is a top view of the receptacle connector of FIG. 25A;

FIG. 26B is a bottom view of the receptacle connector of FIG. 25A;

FIG. 27A is a top view of the plug connector of FIG. 25B;

FIG. 27B is a bottom view of the plug connector of FIG. 25B; and

FIG. 28 is schematic drawing illustrating a state in which the receptacle connector of FIG. 25A and the plug connector of FIG. 25B are fitted together.

### DESCRIPTION OF EMBODIMENTS

Hereinafter, embodiments of the present disclosure are described in detail while referencing the drawings. Note that, in the drawings, identical or corresponding components are denoted with the same reference numerals.

### Embodiment 1

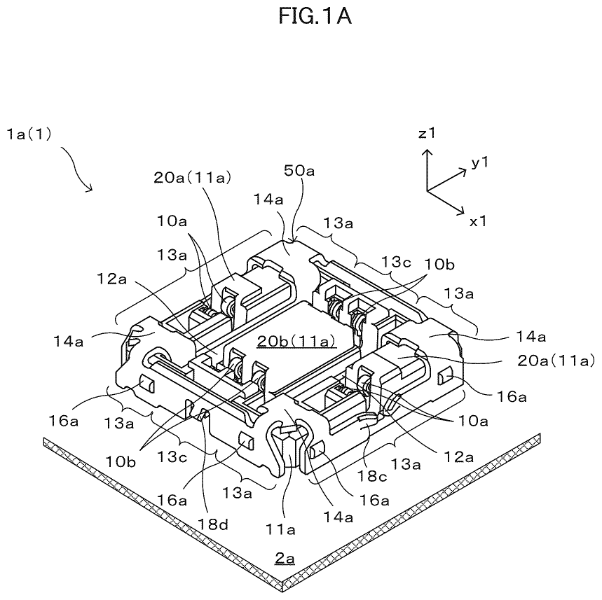

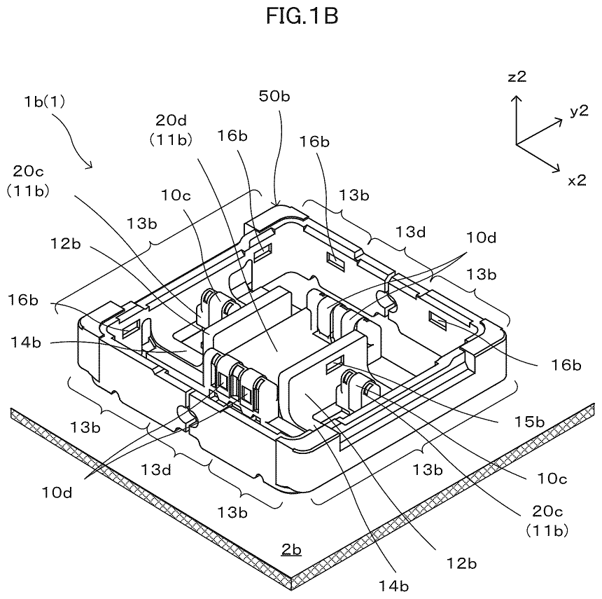

First, Embodiment 1 of the present disclosure is described. An electrical connector pair 1 according to the present embodiment includes a receptacle connector 1a, as a first connector, illustrated in FIG. 1A, and a plug connector 1b, as a second connector, illustrated in FIG. 1B.

As illustrated in FIG. 1A, the receptacle connector 1a is mounted on a main surface of a first substrate 2a. As illustrated in FIG. 1B, the plug connector 1b is mounted on a main surface of a second substrate 2b. Here, the term “main surface” refers to surfaces of the first substrate 2a and the second substrate 2b on which circuit patterns are formed and electronic components are mounted, and refers to the pair of surfaces that have the greatest area of the substrate surfaces.

In the present embodiment, a three-axis Cartesian coordinate system is defined in which an x1-axis direction and a y1-axis direction are in-plane directions of the main surface of the first substrate 2a, and a z1-axis direction is a direction normal to the main surface of the first substrate 2a. Here, the x1-axis direction is the longitudinal direction of the receptacle connector 1a. Additionally, a three-axis Cartesian coordinate system is defined in which an x2-axis direction and a y2-axis direction are in-plane directions of the main surface of the second substrate 2b, and a z2-axis direction is a direction normal to the main surface of the second substrate 2b. Here, the x2-axis direction is the longitudinal direction of the plug connector 1b.

When the receptacle connector 1a and the plug connector 1b are fitted together, the receptacle connector 1a and the plug connector 1b are electrically connected, thereby forming the electrical connector pair 1, and the electronic circuit of the first substrate 2a and the electronic circuit of the second substrate 2b are electrically connected to each other.

### Receptacle Connector

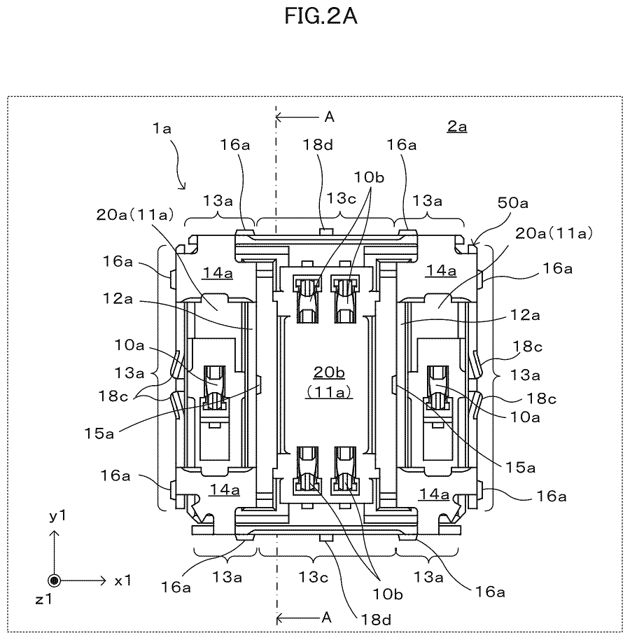

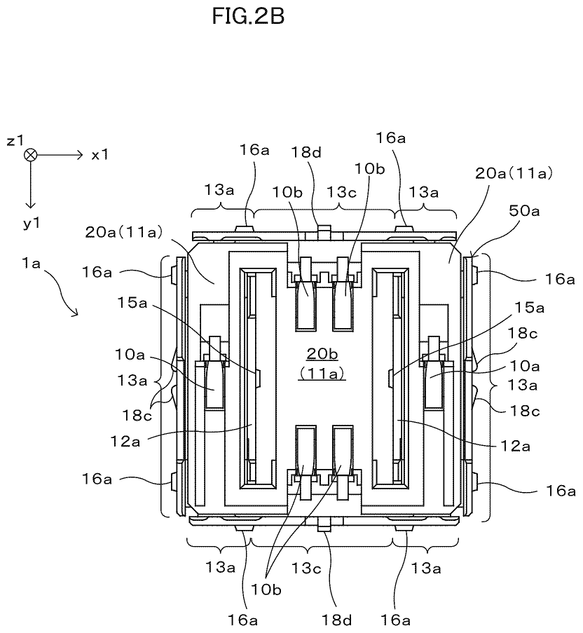

Firstly, the configuration of the receptacle connector 1a is described. As illustrated in FIGS. 2A and 2B, the receptacle connector 1a includes a first contact 10a that is an electrically conductive member, a second contact 10b that is an electrically conductive member, a first housing 11a that is an insulating member, a first partition wall 12a that is an electrically conductive member, a first outer wall 13a that is an electrically conductive member, and a third outer wall 13c that is an electrically conductive member.

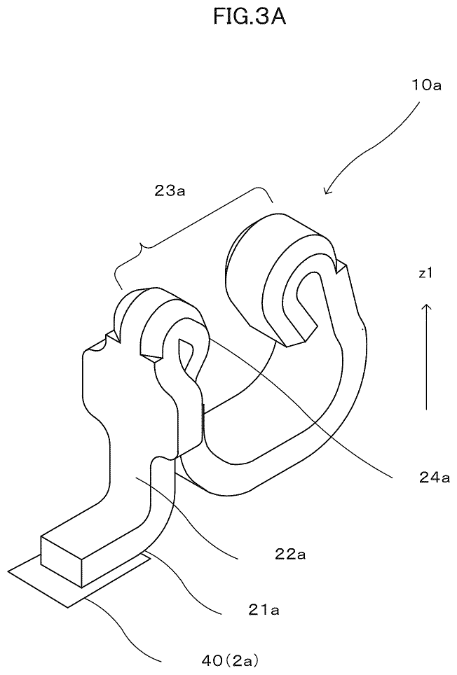

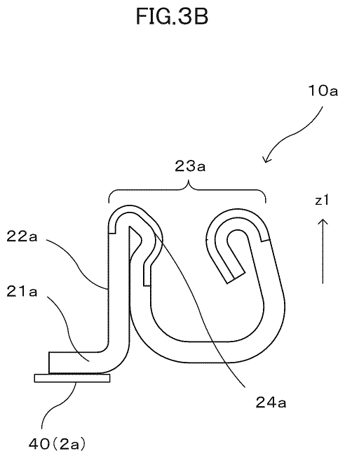

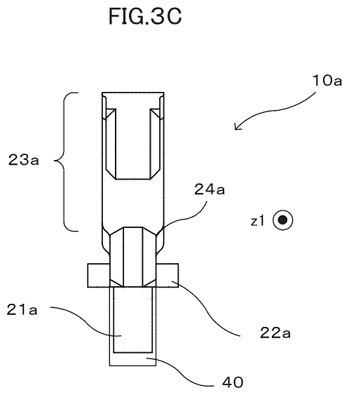

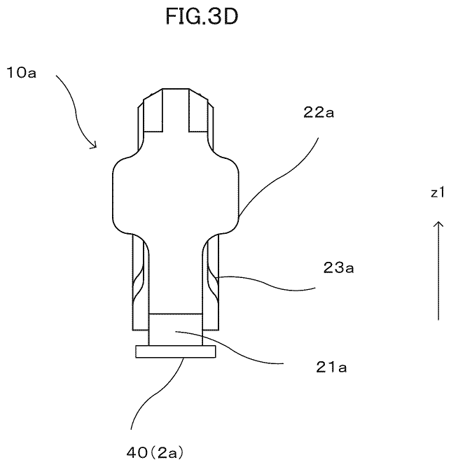

As illustrated in FIGS. 3A, 3B, 3C, and 3D, in one example, the first contact 10a is a metal member and has a bent shape that is, overall, an elongated plate-like shape. A substrate connector 21a is formed at a first end of the first contact 10a. The substrate connector 21a is soldered to a signal electrode 40 of the first substrate 2a.

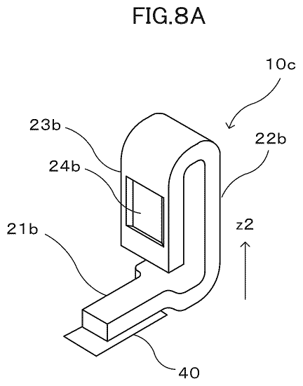

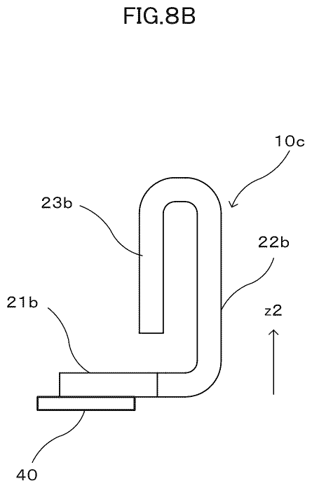

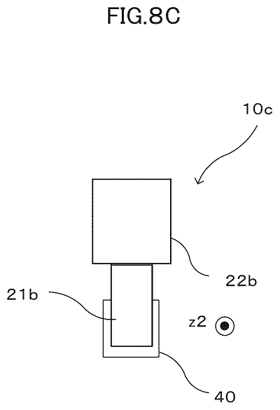

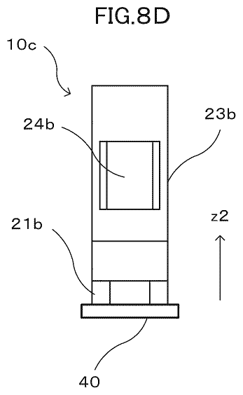

A rising portion 22a of the first contact 10a is bent 90 degrees from the substrate connector 21a and extends in the +z1-axis direction. A section partway along the rising portion 22a is widened, and the first contact 10a is locked to first housing 11a by that widened section. The rising portion 22a is bent in a U-shape at a +z end thereof to form a U-shaped contact contactor 23a, in which a recess facing the +z side is formed, on a tip of the rising portion 22a. A contact contactor 23b (see FIG. 8A) of the third contact 10c of the plug connector 1b is fitted in the contact contactor 23a. A protrusion 24a that fits in a recess 24b (see FIG. 8A) of the second contact 10b is provided on the contact contactor 23a.

As illustrated in FIGS. 2A and 2B, when viewed from the z-axis direction, the longitudinal direction (long side) of the first contact 10a is arranged in a direction matching the y1-axis direction. Note that, in the present specification, the expression “when viewed from . . . ” or “when viewing from . . . ” is used when setting the direction of viewing relative to a subject, and describing the apparent structure of that subject visible from that direction.

In the receptacle connector 1a, a pair of members is provided as the first contact 10a. One first contact 10a is arranged at each of the two ends in the x1-axis direction, along the main surface of the first substrate 2a.

The shape of the second contact 10b is the same as the shape of the first contact 10a illustrated in FIGS. 3A to 3D. As with the first contact 10a, in the second contact 10b, the substrate connector 21a is soldered to the signal electrode 40 of the first substrate 2a. When viewing from the z1-axis direction, the second contact 10b is arranged such that the longitudinal direction thereof matches the y1-axis direction.

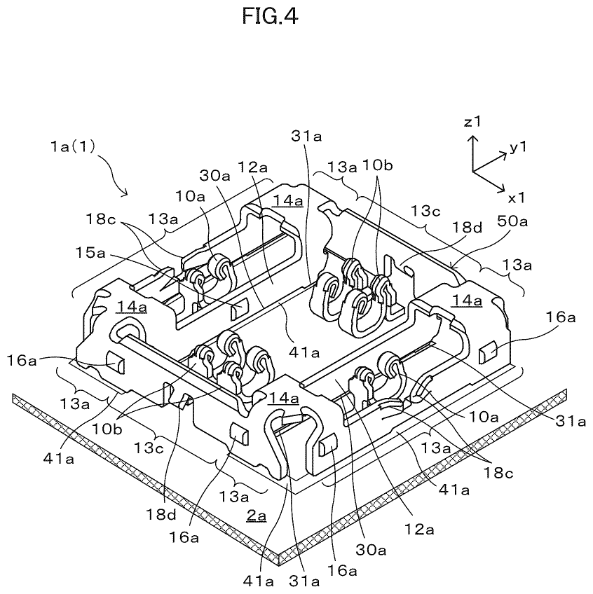

As illustrated in FIG. 4, in the receptacle connector 1a, four of the second contact 10b are arranged at a center portion in the x1-axis direction. In the receptacle connector 1a, the second contacts 10b form a 2×2 matrix in which two second contacts 10b are arranged in the x1-axis direction, and two second contacts 10b are arranged in the y1-axis direction. Note that, in the present embodiment, the positional relationship of each of the first contacts 10a and the second contacts 10b is defined such that a spacing between the second contacts 10b is shorter than a spacing between the second contacts 10b and the first contacts 10a.

The first housing 11a is a member that serves as the parent body of the receptacle connector 1a, and has the x1-axis direction as the longitudinal direction. A resin, for example, is used as the material of the first housing 11a. The first housing 11a includes a back surface that faces the first substrate 2a and a front surface that faces the plug connector 1b when fitting.

The first housing 11a is partitioned into a plurality of regions along the in-plane directions of the first substrate 2a, and a holder of each of the contacts is formed in each region. The first housing 11a includes a first holder 20a that holds the first contact 10a, and a second holder 20b that holds the second contact 10b.

In the receptacle connector 1a, a pair of the first holder 20a is arranged along the x1-axis direction so as to sandwich the second holder 20b. Specifically, the second holder 20b is arranged at the center in the x1-axis direction, and the first holder 20a is arranged at each end in the x1-axis direction.

The first contact 10a, the second contact 10b, and the first partition wall 12a are press-fit into the first housing 11a, and voids for holding are provided. Additionally, voids, into which the constituents of the plug connector 1b enter when fitted together with the plug connector 1b, are provided in the first housing 11a. Furthermore, voids, for confirming connections with the first contact 10a, the second contact 10b, and the signal electrode 40, are provided in the first housing 11a.

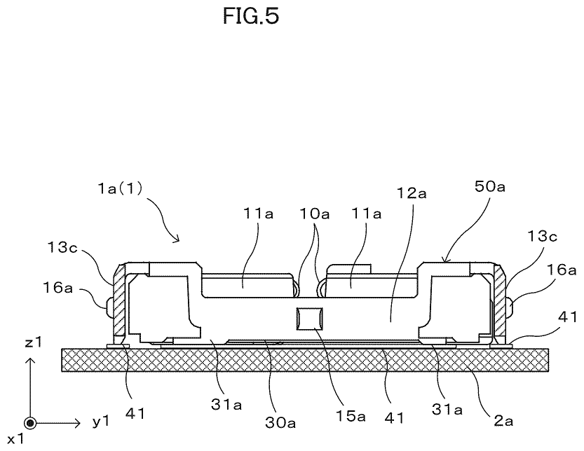

In one example, the first partition wall 12a is a metal member, and is held by the first housing 11a so as to partition the first holder 20a and the second holder 20b. As illustrated in FIGS. 4 and 5, the first partition wall 12a is held by the first housing 11a so as to partition a portion of the boundary between the first holder 20a and the second holder 20b in a state insulated from the first contact 10a and the second contact 10b. Since the first holder 20a is provided at both ends in the x1-axis direction of the second holder 20b, the first partition wall 12a is provided at each of both ends in the x1-axis direction of the second holder 20b. The two first partition walls 12a each extend in the y1-axis direction and partition the first holder 20a and the second holder 20b.

As illustrated in FIGS. 4 and 5, the first partition wall 12a includes a first end 30a that contacts the first substrate 2a. A first ground connector 31a that connects to the ground electrode 41 of the first substrate 2a is provided on the first end 30a. That is, the first partition wall 12a is grounded to the first substrate 2a.

A stopper 15a is provided on the first partition wall 12a. The stopper 15a projects convexly from the wall at a center portion in the y1-axis direction of the first partition wall 12a.

The receptacle connector 1a includes a first shell 50a that is arranged so as to, when viewed from the z1-axis direction, surround the first housing 11a, the first contact 10a, and the second contact 10b on four sides. In one example, the first shell 50a is a metal member, and the first outer wall 13a and the third outer wall 13c are portions of the first shell 50a. The first shell 50a is held by the first holder 20a in a state insulated from the first contact 10a, and is held by the second holder 20b in a state insulated from the second contact 10b. In the present embodiment, the first shell 50a corresponds to a first periphery surrounding wall.

The first outer wall 13a is a portion of the first shell 50a that, when viewed from the z1-axis direction, surrounds the first holder 20a together with the first partition wall 12a. More specifically, the first outer wall 13a includes an opposing wall that opposes the first partition wall 12a, and side walls that respectively extend from each end of the opposing wall toward the third outer wall 13c. The first contact 10a is surrounded by the opposing wall and the side walls, and the first partition wall 12a.

As illustrated in FIG. 4, the first outer wall 13a is connected to the ground electrode 41 of the first substrate 2a. That is, the first outer wall 13a is grounded to the first substrate 2a. Additionally, as illustrated in FIGS. 2A and 2B, when viewed from the z1-axis direction, the first outer wall 13a is arranged outward from an outer shape that includes the end of the substrate connector 21a of the first contact 10a. In the present embodiment, the entire first contact 10a is surrounded by ground members.

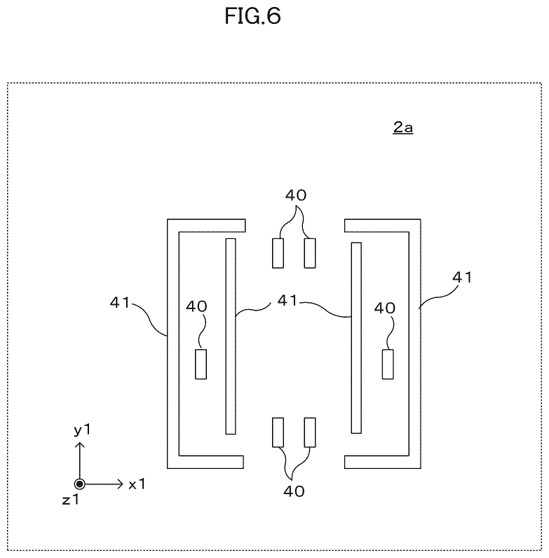

As illustrated in FIG. 6, the signal electrode 40 and the ground electrode 41 are provided on the first substrate 2a. Arrangement locations of the signal electrode 40 correspond to arrangement locations of the first contact 10a and the second contact 10b (see FIG. 2B), and arrangement locations of the ground electrode 41 correspond to arrangement locations of the first partition wall 12a and the first outer wall 13a.

As illustrated in FIGS. 2A and 2B, the first shell 50a includes an electrically conductive first coupler 14a that couples the first partition wall 12a and the first outer wall 13a. The first coupler 14a is a plate-like member that intersects the line normal to the main surface of the first substrate 2a (straight line in the z1-axis direction). As illustrated in FIG. 4, the first coupler 14a couples the first partition wall 12a and the first outer wall 13a on the side far from the first substrate 2a. Due to this, an annular (frame-like) protrusion is formed, by the first partition wall 12a, the first outer wall 13a, and the first coupler 14a, that surrounds the first contact 10a. This annular protrusion functions as an electromagnetic shielding member between the first contact 10a and outside.

As illustrated in FIGS. 2A and 2B, when viewing from the z1-axis direction, the third outer wall 13c is integrated with the first outer wall 13a, and surrounds the first housing 11a on four sides. The third outer wall 13c is a portion that, when viewed from the z1-axis direction, surrounds the second holder 20b of the first housing 11a together with the first partition wall 12a. Note that the third outer wall 13c can be regarded as an electrically conductive member that connects a pair of the first outer walls 13a to each other.

As illustrated in FIG. 4, a stopper 16a is provided on the first outer wall 13a. The stopper 16a projects convexly from the wall main body, and is provided at two locations of the opposing wall, and one location on each of the side walls. Note that the stopper 16a may be provided on the third outer wall 13c. Furthermore, an elastic contactor 18c is provided on the first outer wall 13a. The elastic contactor 18c projects convexly from the wall main body of the first partition wall 12a. Additionally, in the present embodiment, an elastic contactor 18d is provided on the third outer wall 13c. The elastic contactor 18d projects convexly from the wall main body of the third outer wall 13c, and is provided at one location at the center in the x1-axis direction.

As illustrated in FIG. 4, in the receptacle connector 1a, the first contact 10a and the second contact 10b are partitioned by the first partition wall 12a. Additionally, the first contact 10a is surrounded on four sides by the first outer wall 13a and the first partition wall 12a, and the second contact 10b is surrounded on four sides by the third outer wall 13c and the first partition wall 12a. Moreover, as illustrated in FIGS. 4 and 5, in the receptacle connector 1a, the first partition wall 12a is arranged such that a large portion of the first contact 10a cannot be seen from the second contact 10b. In particular, the first partition wall 12a is arranged such that the substrate connector 21a of the first contact 10a cannot be seen from the substrate connector 21a of the second contact 10b.

### Plug Connector

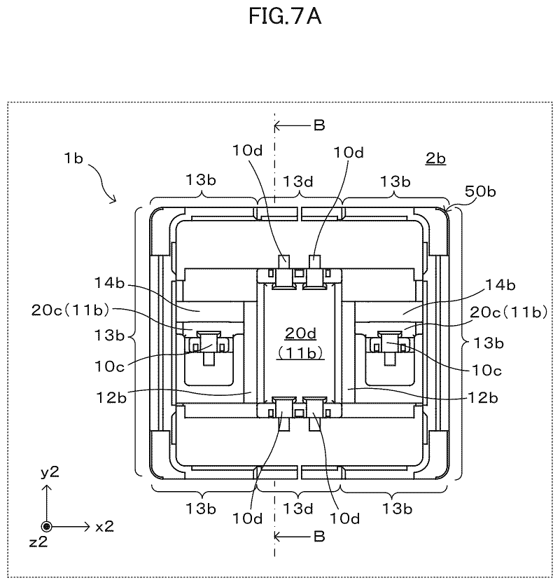

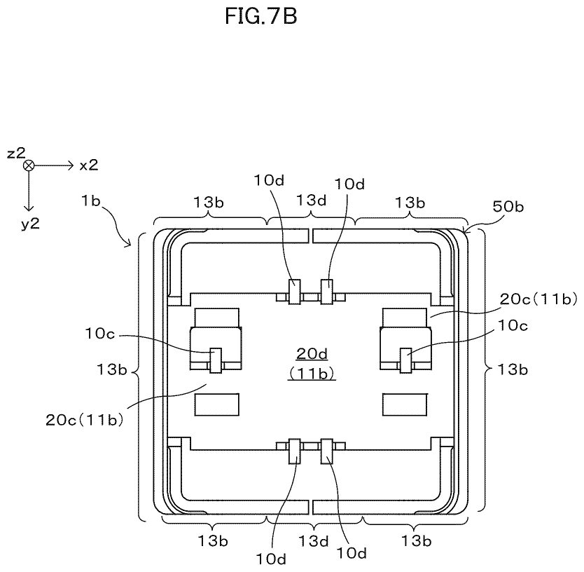

Next, the configuration of the plug connector 1b is described. As illustrated in FIGS. 7A and 7B, the plug connector 1b includes a third contact 10c that is an electrically conductive member, a fourth contact 10d that is an electrically conductive member, a second housing 11b that is an insulating member, a second partition wall 12b that is an electrically conductive member, a second outer wall 13b that is an electrically conductive member, and a fourth outer wall 13d that is an electrically conductive member.

As illustrated in FIGS. 8A,8B, 8C, and 8D, in one example, the third contact 10c is a metal member and has a bent shape that is, overall, an elongated plate-like shape. A substrate connector 21b is formed at a first end of the third contact 10c. As illustrated in FIG. 8A, the substrate connector 21b is soldered to the signal electrode 40 of the second substrate 2b.

A rising portion 22b of the third contact 10c is bent 90 degrees from the substrate connector 21b and extends in the +z direction. Furthermore, a second end of the third contact 10c bends in an upside-down U-shape from the rising portion 22b, and extends toward the substrate connector 21b. A contact contactor 23b is provided on this portion. A recess 24b into which the protrusion 24a of the first contact 10a (see FIG. 3B) fits is provided on the contact contactor 23b.

As illustrated in FIGS. 7A and 7B, when viewing from the z2-axis direction, the third contact 10c is arranged in a direction such that the longitudinal direction thereof matches the y2-axis direction. In the plug connector 1b, a pair of members is provided as the third contact 10c. One third contact 10c is arranged at both ends in the x2-axis direction, along the main surface of the second substrate 2b.

The shape of the fourth contact 10d is the same as the shape of the third contact 10c illustrated in FIGS. 8A to 8D. As with the third contact 10c, in the fourth contact 10d, the substrate connector 21b is soldered to the signal electrode 40 of the second substrate 2b. When viewing from the z2-axis direction, the fourth contact 10d is arranged such that the longitudinal direction thereof matches the y2-axis direction.

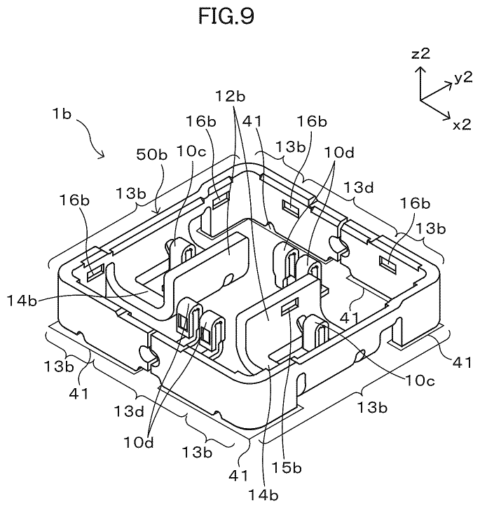

As illustrated in FIG. 9, in the plug connector 1b, four of the fourth contact 10d are arranged at a center portion in the x2-axis direction. In the plug connector 1b, the fourth contacts 10d form a 2×2 matrix in which two fourth contacts 10d are arranged in the x2-axis direction, and two fourth contact 10d are arranged in the y2-axis direction.

The second housing 11b is a member that serves as the parent body of the plug connector 1b, and has the x1-axis direction as the longitudinal direction. A resin, for example, is used as the material of the second housing 11b. The second housing 11b includes a back surface that faces the second substrate 2b and a front surface that faces the receptacle connector 1a when fitted together.

The second housing 11b is partitioned into a plurality of regions along the in-plane directions of the second substrate 2b, and a holder of each of the contacts is formed in each region. The second housing 11b includes a third holder 20c that holds the third contact 10c, and a fourth holder 20d that holds the fourth contact 10d.

In the plug connector 1b, a pair of the third holder 20c is arranged along the x2-axis direction so as to sandwich the fourth holder 20d. Specifically, the fourth holder 20d is arranged at the center in the x2-axis direction, and the third holder 20c is arranged at each end in the x2-axis direction.

The third contact 10c, the fourth contact 10d, and the second partition wall 12b are press-fit into the second housing 11b, and voids for holding are provided. Additionally, voids, into which the constituents of the receptacle connector 1a enter when fitted together with the receptacle connector 1a, are provided in the second housing 11b. Furthermore, voids, for confirming connections with the third contact 10c, the fourth contact 10d, and the signal electrode 40, are provided in the second housing 11b.

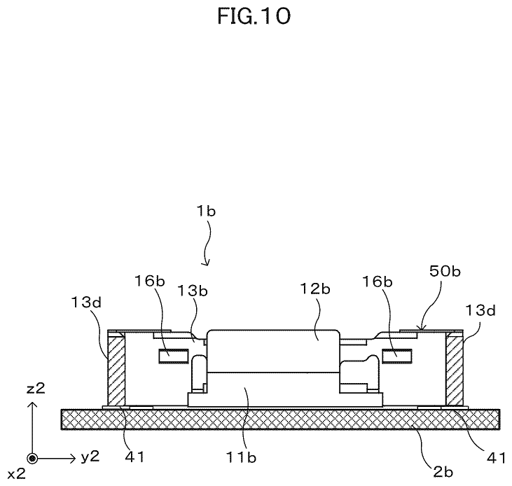

As illustrated in FIG. 7A, in one example, the second partition wall 12b is a metal member, and is held by the second housing 11b so as to partition the third holder 20c and the fourth holder 20d. Specifically, the second partition wall 12b is held by the second housing 11b so as to partition a portion of the boundary between the third holder 20c and the fourth holder 20d in a state insulated from the third contact 10c and the fourth contact 10d (see FIG. 10). Since the third holder 20c is provided at both ends in the x2-axis direction of the fourth holder 20d, the second partition wall 12b is provided at each of both ends in the x2-axis direction of the fourth holder 20d. The two second partition walls 12b each extend in the y2-axis direction and partition the third holder 20c and the fourth holder 20d.

As illustrated in FIG. 9, a stopper 15b is provided on the second partition wall 12b. The stopper 15b is a portion at a center portion in the y2-axis direction of the second partition wall 12b, and is recessed relative to the wall surface.

The plug connector 1b includes a second shell 50b that is arranged so as to, when viewed from the z2-axis direction, surround the second housing 11b, the third contact 10c, and the fourth contact 10d on four sides. In one example, the second shell 50b is a metal member, and the second outer wall 13b and the fourth outer wall 13d are portions of the second shell 50b. The second shell 50b has a size that contacts an outer peripheral portion of the first shell 50a of the receptacle connector 1a. The second shell 50b is held by the third holder 20c in a state insulated from the third contact 10c, and is held by the fourth holder 20d in a state insulated from the fourth contact 10d. In the present embodiment, the second shell 50b corresponds to a second periphery surrounding wall.

The second outer wall 13b is a portion of the second shell 50b that, when viewed from the direction of the line normal to the main surface of the second substrate 2b, surrounds the third holder 20c together with the second partition wall 12b. More specifically, as illustrated in FIGS. 7A and 7B, the second outer wall 13b includes an opposing wall that opposes the second partition wall 12b, and side walls that respectively extend from each end of the opposing wall toward the second partition wall 12d. The third contact 10c is surrounded by the opposing wall and the side walls, and the second partition wall 12b.

As illustrated in FIG. 10, the second outer wall 13b is connected to the ground electrode 41 of the second substrate 2b. That is, the second outer wall 13b is grounded to the second substrate 2b. Additionally, as illustrated in FIGS. 7A and 7B, when viewed from the z2-axis direction, the second outer wall 13b is arranged outward from an outer shape that includes the end of the substrate connector 21a of the third contact 10c. In the present embodiment, the entire third contact 10c is surrounded by ground members.

As illustrated in FIGS. 7A and 7B, the second shell 50b includes an electrically conductive second coupler 14b that couples the second partition wall 12b and the second outer wall 13b. The second coupler 14b is a plate-like member that intersects the line normal to the main surface of the second substrate 2b (the z2-axis direction). Since the second coupler 14b contacts the second substrate 2b, a recess is formed, by the second partition wall 12b, the second outer wall 13b, and the second coupler 14b, that surrounds the third contact 10c. When the plug connector 1b and the receptacle connector 1a are fitted together, the annular protrusion, formed by the first partition wall 12a, the first outer wall 13a, and the first coupler 14a of the receptacle connector 1a, is fitted into this recess.

As illustrated in FIGS. 7A and 7B, when viewing from the z2-axis direction, the fourth outer wall 13d is integrated with the second outer wall 13b, and surrounds the second housing 11b on four sides. The fourth outer wall 13d is a portion that, when viewed from the z2-axis direction, surrounds the fourth holder 20d of the second housing 11b together with the second partition wall 12b. Note that the fourth outer wall 13d can be regarded as an electrically conductive member that connects a pair of the second outer walls 13b to each other.

As illustrated in FIG. 9, a stopper 16b is provided on the second outer wall 13b. The stopper 16b is recessed relative to the wall main body, and is provided at two locations of the opposing wall, and one location on each of the side walls. Note that the stopper 16b may be provided on the fourth outer wall 13d.

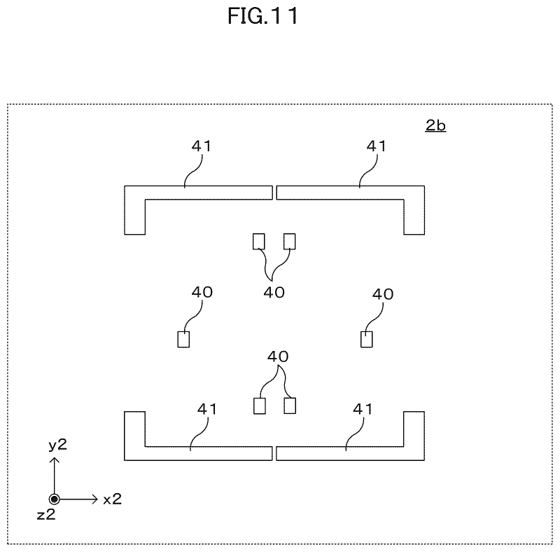

As illustrated in FIG. 11, the signal electrode 40 and the ground electrode 41 are provided on the second substrate 2b. Arrangement locations of the signal electrode 40 correspond to arrangement locations of the third contact 10c and the fourth contact 10d, and arrangement locations of the ground electrode 41 correspond to arrangement locations of the second partition wall 12b, the second outer wall 13b, and the fourth outer wall 13d.

As illustrated in FIG. 9, in the plug connector 1b, the third contact 10c and the fourth contact 10d are partitioned by the second partition wall 12b. Additionally, the third contact 10c is surrounded on four sides by the second outer wall 13b and the second partition wall 12b, and the fourth contact 10d is surrounded on four sides by the fourth outer wall 13d and the second partition wall 12b. As illustrated in FIGS. 9 and 10, in the plug connector 1b, the second partition wall 12b is arranged such that third contact 10c cannot be seen from the fourth contact 10d. In particular, the second partition wall 12b is arranged such that the substrate connector 21a of the third contact 10c cannot be seen from the substrate connector 21a of the fourth contact 10d.

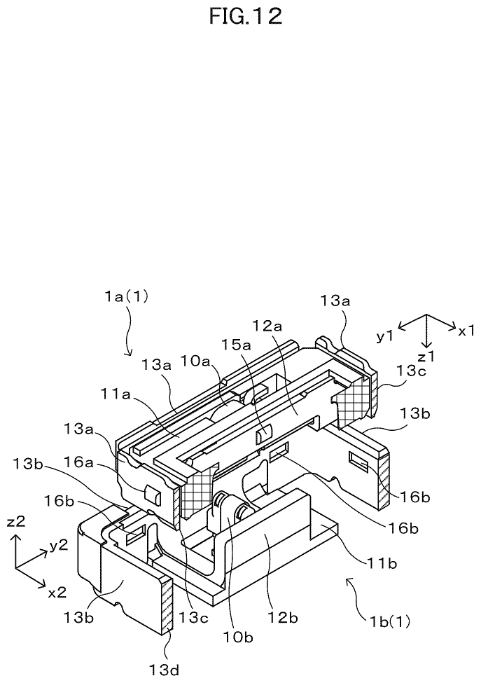

Next, the operations of the electrical connector pair 1 according to some embodiments of the present disclosure are described. Note that the first substrate 2a and the second substrate 2b are omitted in FIGS. 12, 13, 14, and 15 that illustrate the operations.

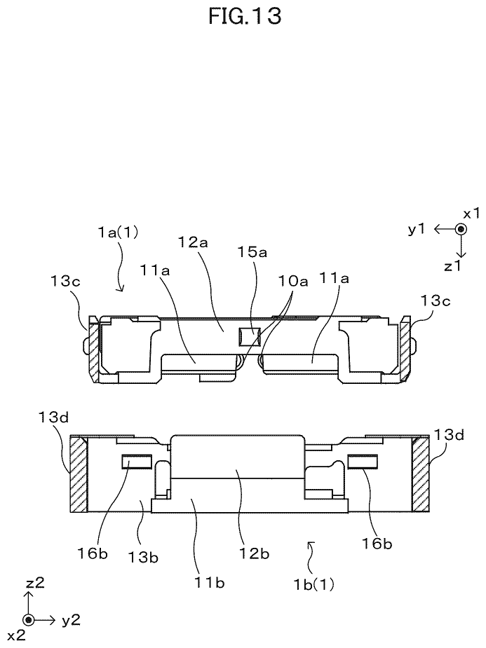

Firstly, as illustrated in FIGS. 12 and 13, the receptacle connector 1a and the plug connector 1b are made to face each other such that the +z1-axis direction and the +z2-axis direction are opposite directions. Furthermore, provided that the first shell 50a is configured to be accommodated in the inner periphery of the second shell 50b, the positions of the annular (frame-like) protrusion formed by the first partition wall 12a, the first outer wall 13a, and the first coupler 14a, and the recess formed by the second outer wall 13b and the second coupler 14b match. Guiding by the protrusion and the recess makes it possible to fit the plug connector 1b and the receptacle connector 1a together. As a result, the stopper 16a and the stopper 16b engage. Additionally, the elastic contactor 18c presses against and contacts the second outer wall 13b, and the elastic contactor 18d presses against and contacts the fourth outer wall 13d.

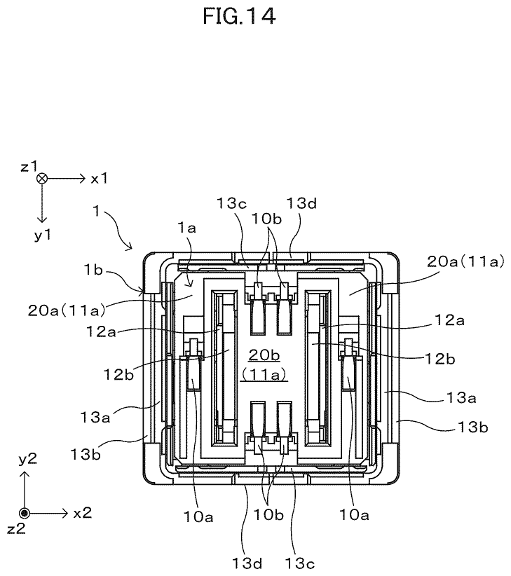

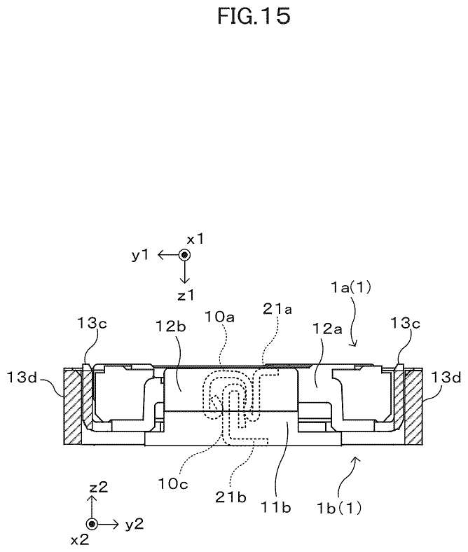

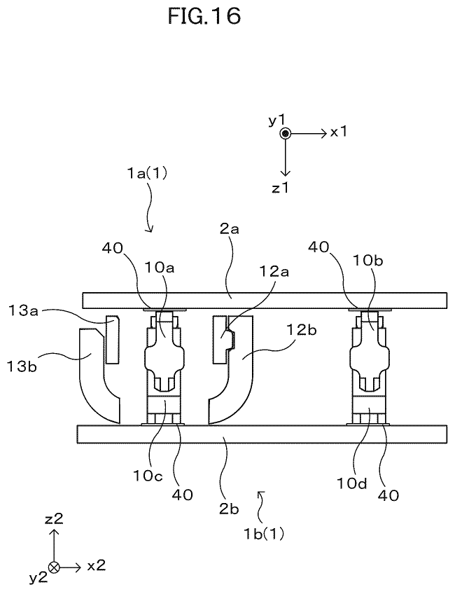

When the receptacle connector 1a and the plug connector 1b are fitted together as illustrated in FIGS. 14, 15, and 16, the first contact 10a and the third contact 10c contact as illustrated in FIG. 15. As a result, as illustrated in FIG. 16, a signal transmission path, specifically, the signal electrode 40 of the first substrate 2a→the first contact 10a→the third contact 10c→the signal electrode 40 of the second substrate 2b is formed.

Additionally, when the receptacle connector 1a and the plug connector 1b are fitted together, as with the first contact 10a and the third contact 10c, the second contact 10b and the fourth contact 10d contact. As a result, a signal transmission path, specifically, the signal electrode 40 of the first substrate 2a→the second contact 10b→the fourth contact 10d→the signal electrode 40 of the second substrate 2b is formed.

Furthermore, when the receptacle connector 1a and the plug connector 1b are fitted together, as illustrated in FIG. 14, the first partition wall 12a and the second partition wall 12b become adjacent in the x1-axis direction, and assume a contacting state. In this case, as illustrated in FIG. 14, the second contact 10b and the fourth contact 10d, and the first contact 10a and the third contact 10c are partitioned by the first partition wall 12a and the second partition wall 12b. Additionally, as illustrated in FIGS. 15 and 16, due to the first partition wall 12a and the second partition wall 12b, the first contact 10a and the third contact 10c cannot be seen from the second contact 10b and the fourth contact 10d. Specifically, when the receptacle connector 1a and the plug connector 1b are fitted together, the first partition wall 12a partitions a portion of the boundary between the third holder 20c and the fourth holder 20d where the second partition wall 12b is not formed such that the first contact 10a and the third contact 10c cannot be seen from the second contact 10b and the fourth contact 10d. As a result, electromagnetic noise that is introduced to the second contact 10b and the fourth contact 10d from the first contact 10a and the third contact 10c can be reduced and, furthermore, leakage of electromagnetic noise from the second contact 10b and the fourth contact 10d to the first contact 10a and the third contact 10c can be further reduced.

More specifically, the second partition wall 12b is arranged so as to overlap the first partition wall 12a when viewing from the first contact 10a and the third contact 10c. That is, as illustrated in FIG. 14, when viewing from the first contact 10a and the third contact 10c, the first outer wall 13a and the second outer wall 13b are arranged doubly. Due to this configuration, the electromagnetic noise component that is introduced to the second contact 10b and the fourth contact 10d from the first contact 10a and the third contact 10c can be further reduced, and the electromagnetic noise component that is introduced to the first contact 10a and the third contact 10c from the second contact 10b and the fourth contact 10d can be further reduced.

Note that, when the receptacle connector 1a and the plug connector 1b are fitted together, the stopper 15a of the first partition wall 12a and the stopper 15b of the second partition wall 12b engage, and the stopper 16a of the first outer wall 13a and the stopper 16b of the second outer wall 13b engage. As a result, the fitting force between the receptacle connector 1a and the plug connector 1b can be increased. Moreover, since the first outer wall 13a and the second outer wall 13b conduct, these components are more likely to trap electromagnetic noise.

When the receptacle connector 1a and the plug connector 1b are fitted together, as illustrated in FIG. 14, when viewing from the second contact 10b and the fourth contact 10d, the third outer wall 13c and the fourth outer wall 13d are arranged doubly. Due to this configuration, the electromagnetic noise component that is introduced to the second contact 10b and the fourth contact 10d from outside can be further reduced, and the electromagnetic noise component emitted outside from the second contact 10b and the fourth contact 10d can be further reduced.

### Embodiment 2

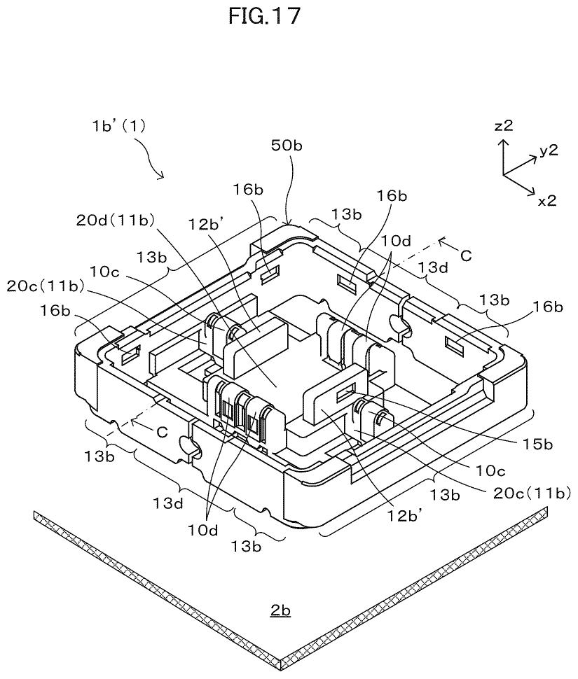

Next, Embodiment 2 of the present disclosure is described. An electrical connector pair 1 according to the present embodiment is the same as the electrical connector pair 1 of Embodiment 1 in that it includes a receptacle connector 1a and a plug connector 1b. As illustrated in FIG. 17, a plug connector 1b′ includes, in place of the second partition wall 12b, a second partition wall 12b′ that is an electrically conductive member.

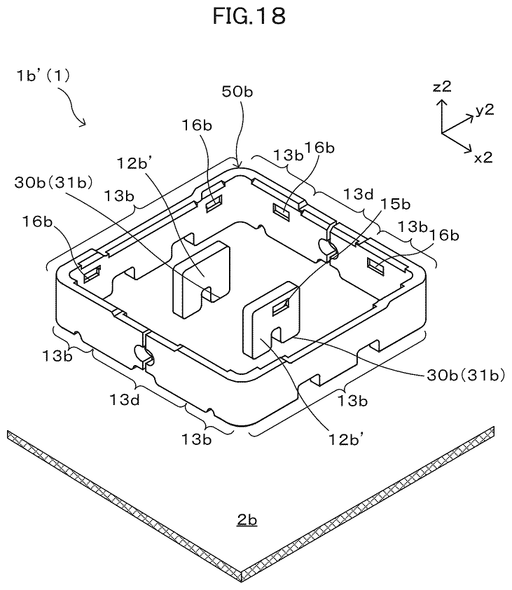

As with the second partition wall 12b, the second partition wall 12b′ is held by the second housing 11b so as to partition the third holder 20c and the fourth holder 20d. However, as illustrated in FIG. 18, the second partition wall 12b′ is not coupled to the second outer wall 13b. In the present embodiment, the second partition wall 12b′ does not need to be coupled to the second partition wall 13b or the fourth outer wall 13d. Specifically, the second partition wall 12b′ is held by the second housing 11b so as to partition a portion of the boundary between the third holder 20c and the fourth holder 20d in a state insulated from the third contact 10c and the fourth contact 10d.

As illustrated in FIG. 18, the second partition wall 12b′ includes a second end 30b that contacts the second substrate 2b. A second ground connector 31b that connects to the ground electrode 41 of the second substrate 2b is provided on the second end 30b.

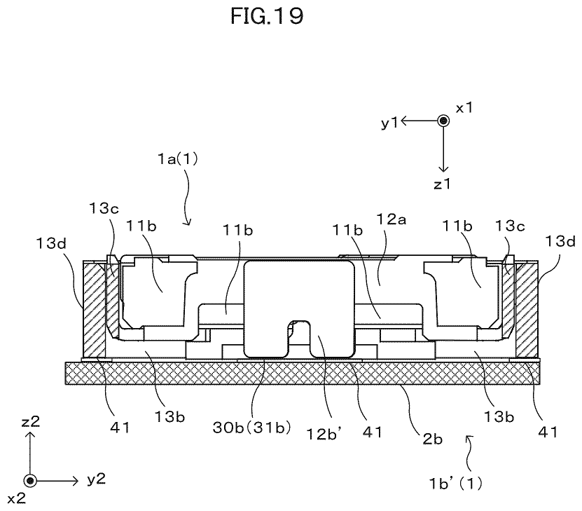

As illustrated in FIGS. 17 and 19, due to the first partition wall 12a and the second partition wall 12b′, the first contact 10a and the third contact 10c cannot be seen from the second contact 10b and the fourth contact 10d. Specifically, when the receptacle connector 1a and the plug connector 1b′ are fitted together, the first partition wall 12a partitions a portion of the boundary between the third holder 20c and the fourth holder 20d where the second partition wall 12b′ is not formed such that the first contact 10a and the third contact 10c cannot be seen from the second contact 10b and the fourth contact 10d. As a result, electromagnetic noise that is introduced to the second contact 10b and the fourth contact 10d from the first contact 10a and the third contact 10c can be reduced and, furthermore, leakage of electromagnetic noise from the second contact 10b and the fourth contact 10d to the first contact 10a and the third contact 10c can be further reduced.

### Embodiment 3

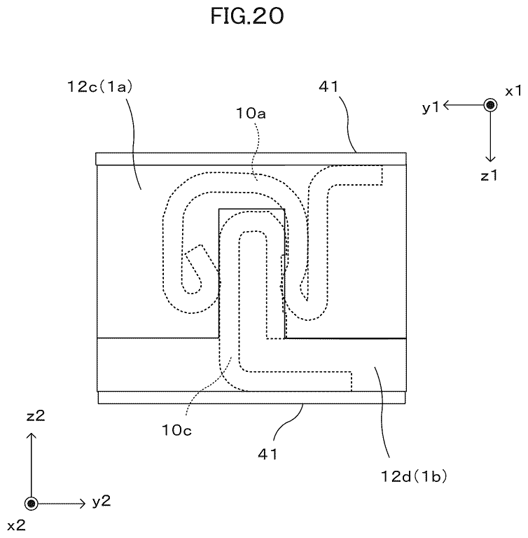

Next, Embodiment 3 of the present disclosure is described. An electrical connector pair 1 according to the present embodiment is the same as the electrical connector pair 1 of Embodiments 1 and 2 in that it includes a receptacle connector 1a and a plug connector 1b. As illustrated in FIG. 20, in the present embodiment, the receptacle connector 1a includes, in place of the first partition wall 12a, a first partition wall 12c, and the plug connector 1b includes, in place of the second partition wall 12b, a second partition wall 12d.

As illustrated in FIG. 20, in the receptacle connector 1a, when viewing from the x1-axis side, a center portion in the y1-axis direction of the first partition wall 12c is notched. Additionally, in the plug connector 1b, when viewing from the x2-axis side, a center portion in the y2-axis direction of the second partition wall 12d is protruding.

When the receptacle connector 1a and the plug connector 1b are fitted together, the first partition wall 12c and the second partition wall 12d fit together to form a single partition wall extending in the y1- and y2-axis directions. Due to this configuration, the first partition wall 12c and the second partition wall 12d can prevent the electromagnetic noise generated by the second contact 10b and the fourth contact 10d from being introduced to the first contact 10a and the third contact 10c, and vice-versa.

As with the first partition wall 12a according to the embodiments described above, in the present embodiment, the first partition wall 12c may or may not be coupled to the first outer wall 13a. As with the second partition wall 12b according to the embodiments described above, the second partition wall 12d may be coupled to the second outer wall 13b or, as with the second partition wall 12b′, may not be coupled to the second outer wall 13b.

Additionally, the first partition wall 12c is provided such that the first contact 10a cannot be seen from the second contact 10b, and the second partition wall 12d is provided such that the third contact 10c cannot be seen from the fourth contact 10d. A single partition wall can be formed by fitting the first partition wall 12c and the second partition wall 12d together.

### Embodiment 4

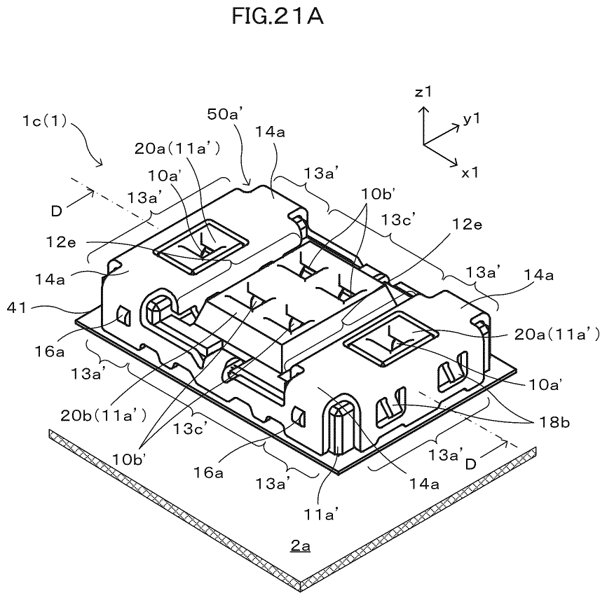

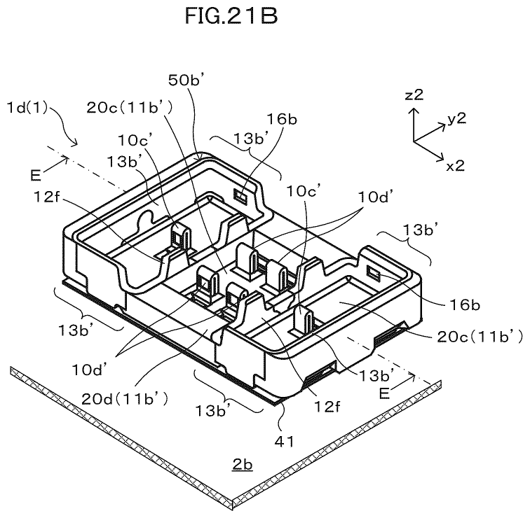

Next, Embodiment 4 of the present disclosure is described. As illustrated in FIGS. 21A and 21B, an electrical connector pair 1 according to the present embodiment includes a receptacle connector 1c as a first connector, and a plug connector 1d as a second connector. The receptacle connector 1c is mounted on a main surface of a first substrate 2a, and the plug connector 1d is mounted on a main surface of a second substrate 2b.

### Receptacle Connector

As illustrated in FIG. 21A, the receptacle connector 1c includes a first contact 10a′ that is an electrically conductive member, a second contact 10b′ that is an electrically conductive member, a first housing 11a′ that is an insulating member, a first partition wall 12e that is an electrically conductive member, a first outer wall 13a′ that is an electrically conductive member, and a third outer wall 13c′ that is an electrically conductive member.

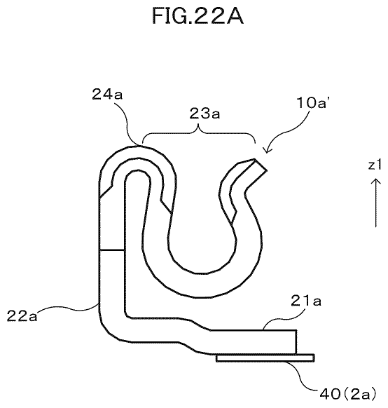

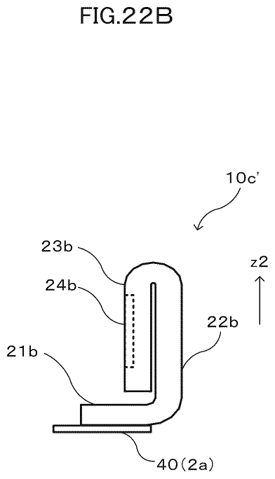

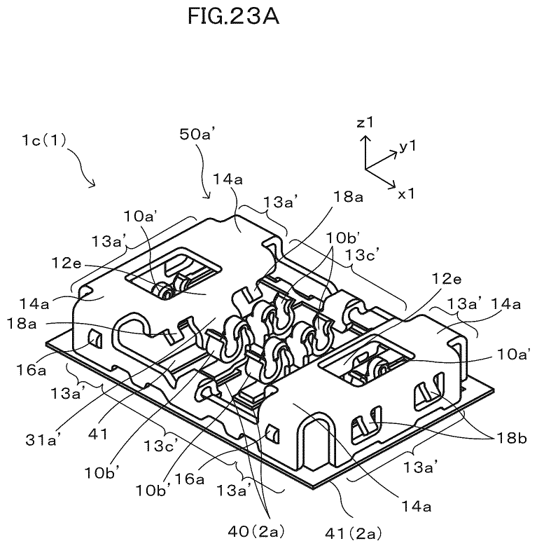

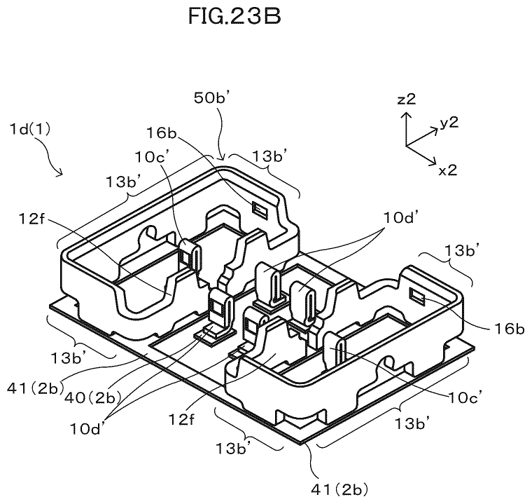

As illustrated in FIG. 22A, the configuration of the first contact 10a′ is the same as the configuration of the first contact 10a (FIG. 3A) in that it includes a substrate connector 21a, a rising portion 22a, a contact contactor 23a, and a protrusion 24a. However, in the first contact 10a′, the direction in which the substrate connector 21a extends with respect to the rising portion 22a is opposite that of the first contact 10a. As illustrated in FIG. 23A, one first contact 10a′ is arranged at both ends in the x1-axis direction, along the main surface of the first substrate 2a.

The configuration of the second contact 10b′ is the same as the configuration of the first contact 10a′. When viewing from the z1-axis direction, the second contact 10b′ is arranged such that the longitudinal direction thereof matches the y1-axis direction. The arrangement of the second contact 10b′is the same as the arrangement of the second contact 10b described above (see FIG. 4).

As illustrated in FIG. 21A, the first housing 11a′ includes a first holder 20a that holds the first contact 10a′, and a second holder 20b that holds the second contact 10b′. The second holder 20b is arranged at the center in the x1-axis direction, and the first holder 20a is arranged at each end in the x1-axis direction.

The first partition wall 12e is held by the first housing 11a′ so as to partition the first holder 20a and the second holder 20b. Since the first holder 20a is provided at both ends in the x1-axis direction of the second holder 20b, the first partition wall 12e is provided at each of both ends in the x1-axis direction of the second holder 20b. The two first partition walls 12e each extend in the y1-axis direction and partition the first holder 20a and the second holder 20b.

As illustrated in FIG. 23A, an elastic contactor 18a is provided on the first partition wall 12e. The elastic contactor 18a is a plate-like member, and projects in a bent manner from the main body of the first partition wall 12e.

The receptacle connector 1c includes a first shell 50a′ that, when viewing from the z1-axis direction, surrounds the first housing 11a′ on four sides. In one example, the first shell 50a′ is a metal member, and the first outer wall 13a′ and the third outer wall 13c′ are portions of the first shell 50a′.

As illustrated in FIG. 21A, the first outer wall 13a′ is a portion of the first shell 50a′ that, when viewed from the z1-axis direction, surrounds the first holder 20a together with the first partition wall 12e. More specifically, the first outer wall 13a′ includes an opposing wall that opposes the first partition wall 12e, and side walls that respectively extend from each end of the opposing wall toward the third outer wall 13c′. The first contact 10a′ is surrounded by the opposing wall and the side walls, and the first partition wall 12e.

As illustrated in FIG. 23A, the first outer wall 13a′ includes a first ground connector 31a′ that is connected to the ground electrode 41 of the first substrate 2a. That is, the first outer wall 13a′ is grounded to the first substrate 2a.

As illustrated in FIG. 23A, the first shell 50a′ includes an electrically conductive first coupler 14a that couples the first partition wall 12e and the first outer wall 13a′. The first coupler 14a is a plate-like member that intersects the line normal to the main surface of the first substrate 2a (straight line in the z1-axis direction). The first coupler 14a couples the first partition wall 12e and the first outer wall 13a′ on the side far from the first substrate 2a. Due to this, an annular (frame-like) protrusion is formed, by the first partition wall 12e, the first outer wall 13a′, and the first coupler 14a, that surrounds the first contact 10a′. This annular protrusion functions as an electromagnetic shielding member between the first contact 10a′ and outside.

As illustrated in FIG. 21A, when viewing from the z1-axis direction, the third outer wall 13c′ is integrated with the first outer wall 13a′, and surrounds the first housing 11a′ on four sides. The third outer wall 13c′ is a portion that, when viewed from the z1-axis direction, surrounds the second holder 20b of the first housing 11a together with the first partition wall 12e. Note that the third outer wall 13c′ can be regarded as an electrically conductive member that connects a pair of the first outer walls 13a′ to each other.

As illustrated in FIGS. 21A and 23A, a stopper 16a is provided on the first outer wall 13a′. The stopper 16a projects convexly from the wall main body, and is provided at one location on each of the side walls. Note that the stopper 16a may be provided on the third outer wall 13c′. Additionally, an elastic contactor 18b is provided on the first outer wall 13a′. The elastic contactor 18b is a portion that protrudes in a plate-like manner, and extends in a direction away from the main body of the first outer wall 13a.

As illustrated in FIG. 23A, in the receptacle connector 1c, the first contact 10a′ and the second contact 10b′ are partitioned by the first partition wall 12e. Additionally, the first contact 10a′ is surrounded on four sides by the first outer wall 13a′ and the first partition wall 12e, and the second contact 10b′ is surrounded on four sides by the third outer wall 13c′ and the first partition wall 12e. In the receptacle connector 1c, the first partition wall 12e is arranged such that a large portion of the first contact 10a′ cannot be seen from the second contact 10b′.

### Plug Connector

Next, the configuration of the plug connector 1d is described. As illustrated in FIG. 21B, the plug connector 1d includes a third contact 10c′ that is an electrically conductive member, a fourth contact 10d′ that is an electrically conductive member, a second housing 11b′ that is an insulating member, a second partition wall 12f that is an electrically conductive member, and a second outer wall 13b′ that is an electrically conductive member.

As illustrated in FIG. 22B, the configuration of the third contact 10c′ is the same as the configuration of the third contact 10c (FIG. 8B) in that it includes a substrate connector 21b, a rising portion 22b, a contact contactor 23b, and a recess 24b. As illustrated in FIG. 23B, one third contact 10c′ is arranged at both ends in the x2-axis direction, along the main surface of the second substrate 2b (see FIG. 21B).

The configuration of the fourth contact 10d′ is the same as the configuration of the third contact 10c′. When viewing from the z2-axis direction, the fourth contact 10d′ is arranged such that the longitudinal direction thereof matches the y2-axis direction. The arrangement of the fourth contact 10d′ is the same as the arrangement of the fourth contact 10d described above (see FIG. 9).

As illustrated in FIG. 21B, the second housing 11b′ includes a third holder 20c that holds the third contact 10c′, and a fourth holder 20d that holds the fourth contact 10d′. The fourth holder 20d is arranged at the center in the x2-axis direction, and the third holder 20c is arranged at each end in that x2-axis direction.

The second partition wall 12f is held by the second housing 11b′ so as to partition the third holder 20c and the fourth holder 20d. Since the third holder 20c is provided at both ends in the x2-axis direction of the fourth holder 20d, the second partition wall 12f is provided at each of both ends in the x2-axis direction of the fourth holder 20d. The two second partition walls 12f each extend in the y2-axis direction and partition the third holder 20c and the fourth holder 20d.

The plug connector 1d includes a second shell 50b′ that is a metal member and that, when viewing from the z2-axis direction, surrounds the second housing 11b on four sides. The second outer wall 13b′ is a portion of the second shell 50b′. The second shell 50b′ has a size that contacts an outer peripheral portion of the first shell 50a′ of the receptacle connector 1c.

The second outer wall 13b′ is a portion of the second shell 50b′ that, when viewed from the direction of the line normal to the main surface of the second substrate 2b, surrounds the third holder 20c together with the second partition wall 12f. More specifically, as illustrated in FIG. 23B, the second outer wall 13b′ includes an opposing wall that opposes the second partition wall 12f, and side walls that respectively extend from each end of the opposing wall toward the second partition wall 12f. The third contact 10c′ is surrounded by the opposing wall and the side walls, and the second partition wall 12f.

As illustrated in FIG. 23B, the second outer wall 13b′ is connected to the ground electrode 41 of the second substrate 2b. That is, the second outer wall 13b′ is grounded to the second substrate 2b. Additionally, when viewed from the z2-axis direction, the second outer wall 13b′ is arranged outward from an outer shape that includes the end of the substrate connector 21a of the third contact 10c′. In the present embodiment, the entire third contact 10c′ is surrounded by ground members.

As illustrated in FIG. 23B, in the second shell 50b′, the second partition wall 12f and the second outer wall 13b′ are coupled. A recess is formed, by the second partition wall 12f and the second outer wall 13b′, that surrounds the third contact 10c′. When the plug connector 1d and the receptacle connector 1c are fitted together, an annular protrusion, formed by the first partition wall 12e, the first outer wall 13a′, and the first coupler 14a of the receptacle connector 1c, is fitted into this recess.

A stopper 16b is provided on the second outer wall 13b′. The stopper 16b is a portion that is recessed relative to the wall main body, and is provided at one location on each of the side walls.

As illustrated in FIG. 23B, in the plug connector 1d, the third contact 10c′ and the fourth contact 10d′ are partitioned by the second partition wall 12f. Additionally, the third contact 10c′ is surrounded on four sides by the second outer wall 13b′ and the second partition wall 12f. In the plug connector 1d, the second partition wall 12f is arranged such that a large portion of the third contact 10c′ cannot be seen from the fourth contact 10d′. In particular, the second partition wall 12f is arranged such that the substrate connector 21a of the third contact 10c′ cannot be seen from the substrate connector 21a of the fourth contact 10d′.

Next, the operations of the electrical connector pair 1 according to the present embodiment are described.

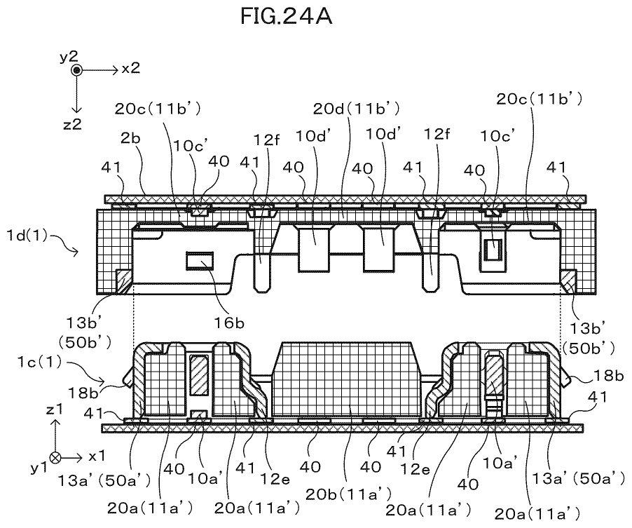

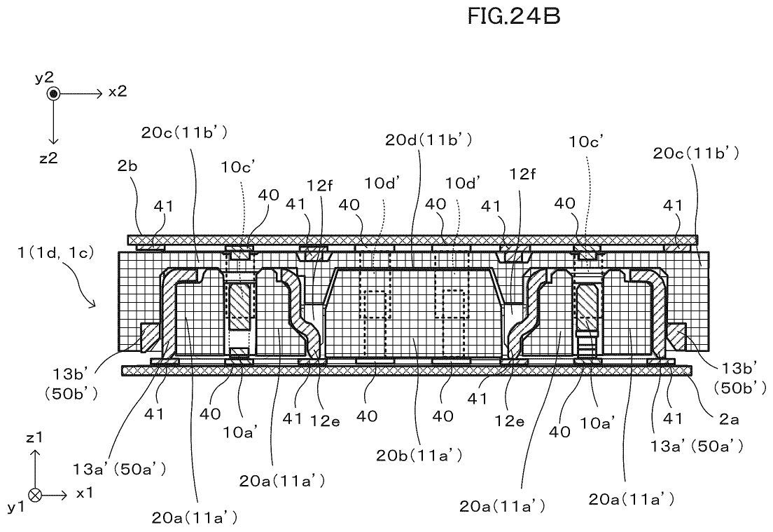

As illustrated in FIG. 24A, the receptacle connector 1c and the plug connector 1d are made to face each other such that the +z1-axis direction and the +z2-axis direction are opposite directions. Furthermore, provided that the first shell 50a′ is configured to be accommodated in the inner periphery of the second shell 50b′, the positions of the annular (frame-like) protrusion formed by the first partition wall 12e, the first outer wall 13a′, and the first coupler 14a, and the recess formed by the second outer wall 12f and the second outer wall 13b′ match. Guiding by the protrusion and the recess makes it possible to fit the plug connector 1d and the receptacle connector 1c together. As a result, the stopper 16a (see FIG. 23A) and the stopper 16b (see FIG. 23B) engage. Additionally, the elastic contactor 18a of the first partition wall 12e presses against and contacts the second partition wall 12f, and the elastic contactor 18b of the first outer wall 13a′ presses against and contacts the second outer wall 13b′.

As illustrated in FIG. 24B, when the receptacle connector 1c and the plug connector 1d are fitted together, the first contact 10a′ and the third contact 10c′ contact. As a result, a signal transmission path, specifically, the signal electrode 40 of the first substrate 2a→the first contact 10a′→the third contact 10c′→the signal electrode 40 of the second substrate 2b is formed.

Additionally, when the receptacle connector 1c and the plug connector 1d are fitted together, as with the first contact 10a′ and the third contact 10c′, the second contact 10b′ and the fourth contact 10d′ contact. As a result, a signal transmission path, specifically, the signal electrode 40 of the first substrate 2a→the second contact 10b′→the fourth contact 10d′→the signal electrode 40 of the second substrate 2b is formed.

Furthermore, when the receptacle connector 1c and the plug connector 1d are fitted together, the first partition wall 12e and the second partition wall 12f become adjacent in the x1-axis direction, and assume a contacting state. In this case, the second contact 10b′ and the fourth contact 10d′, and the first contact 10a′ and the third contact 10c′ are doubly partitioned by the first partition wall 12e and the second partition wall 12f. Due to the first partition wall 12e and the second partition wall 12f, the first contact 10a′ and the third contact 10c′ cannot be seen from the second contact 10b′ and the fourth contact 10d′. As a result, electromagnetic noise that is introduced to the second contact 10b′ and the fourth contact 10d′ from the first contact 10a′ and the third contact 10c′ can be reduced and, furthermore, leakage of electromagnetic noise from the second contact 10b′ and the fourth contact 10d′ to the first contact 10a′ and the third contact 10c′ can be further reduced.

### Embodiment 5

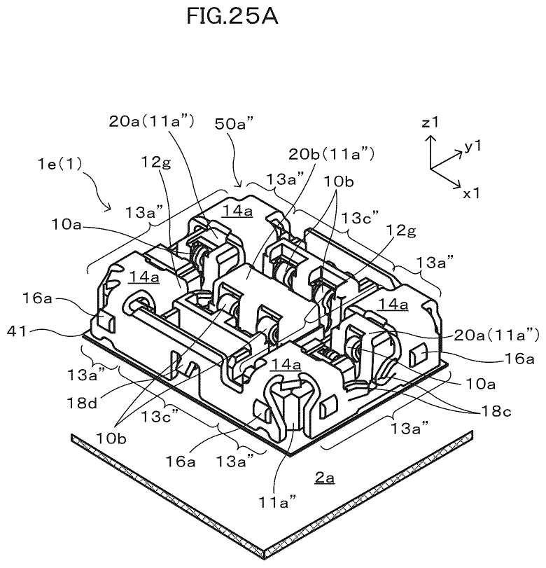

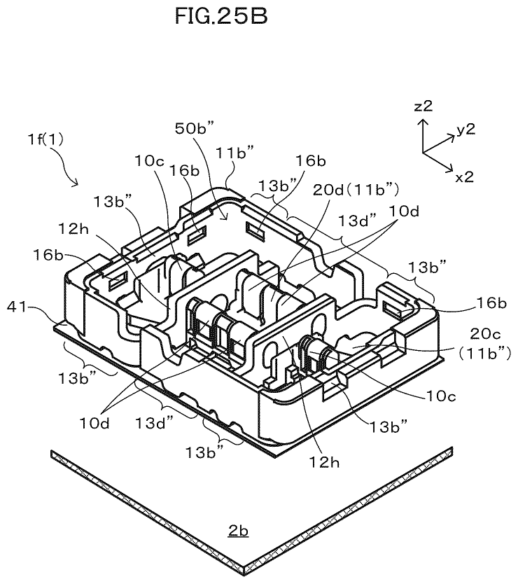

Next, Embodiment 5 of the present disclosure is described. As illustrated in FIGS. 25A and 25B, an electrical connector pair 1 according to the present embodiment includes a receptacle connector 1e as a first connector, and a plug connector If as a second connector. The receptacle connector 1e is mounted on a main surface of a first substrate 2a, and the plug connector If is mounted on a main surface of a second substrate 2b.

### Receptacle Connector

As illustrated in FIG. 25A, the receptacle connector 1e includes a first contact 10a that is an electrically conductive member, a second contact 10b that is an electrically conductive member, a first housing 11a″ that is an insulating member, a first partition wall 12g that is an electrically conductive member, a first outer wall 13a″ that is an electrically conductive member, and a third outer wall 13c″ that is an electrically conductive member.

The configurations, shapes, and arrangements of the first contact 10a and the second contact 10b are the same as the configurations, shapes, and arrangements of the first contact 10a and the second contact 10b of the receptacle connector 1a according to the embodiments described above. However, the sizes of the first contact 10a and the second contact 10b according to the present embodiment differ from those of the first contact 10a and the second contact 10b according to Embodiment 1. Specifically, a width in the x1-axis direction of the first contact 10a is smaller than that of the second contact 10b.

The first partition wall 12g is held by the first housing 11a″ so as to partition the first holder 20a and the second holder 20b. Since the first holder 20a is provided at both ends in the x1-axis direction of the second holder 20b, the first partition wall 12g is provided at each of both ends in the x1-axis direction of the second holder 20b. The two first partition walls 12g each extend in the y1-axis direction and partition the first holder 20a and the second holder 20b.

As illustrated in FIG. 25A, an elastic contactor 18c is provided on the first partition wall 12g. The elastic contactor 18c projects convexly from the wall main body of the first partition wall 12g.

The receptacle connector 1e includes a first shell 50a″ that, when viewing from the z1-axis direction, surrounds the first housing 11a″ on four sides. In one example, the first shell 50a″ is a metal member, and the first outer wall 13a″ and the third outer wall 13c″ are portions of the first shell 50a″.

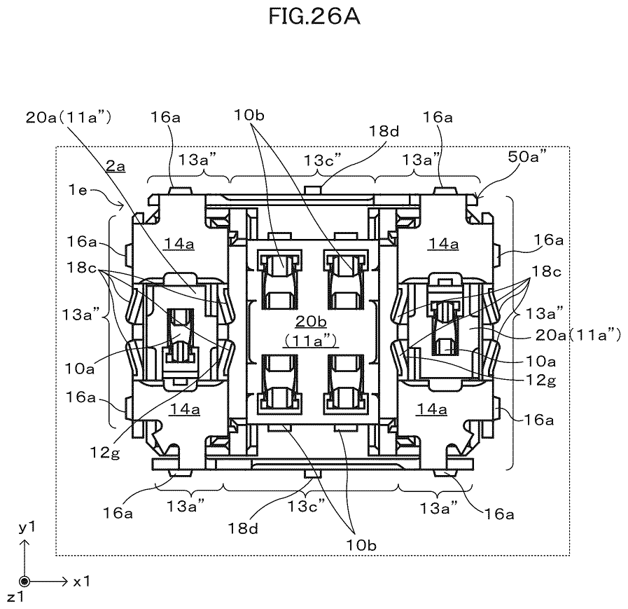

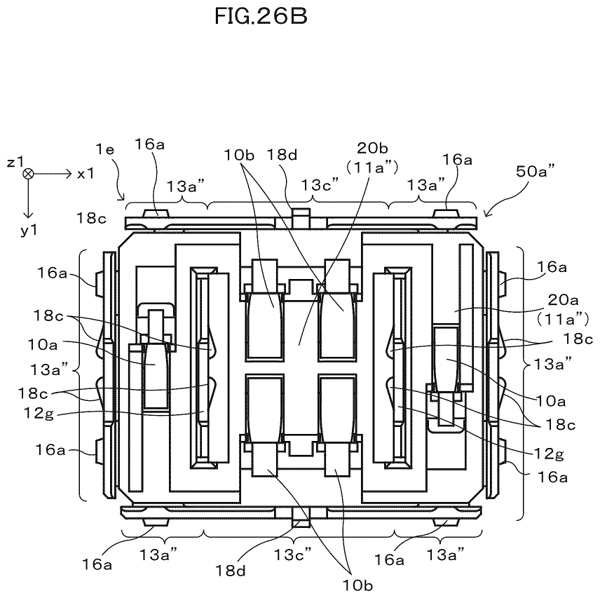

As illustrated in FIGS. 26A and 26B, the first outer wall 13a″ is a portion of the first shell 50a″ that, when viewed from the z1-axis direction, surrounds the first holder 20a together with the first partition wall 12g. More specifically, the first outer wall 13a″ includes an opposing wall that opposes the first partition wall 12g, and side walls that respectively extend from each end of the opposing wall toward the third outer wall 13c″. The first contact 10a is surrounded by the opposing wall and the side walls, and the first partition wall 12g.

The first outer wall 13a″ is connected to the ground electrode 41 of the first substrate 2a. Specifically, the first outer wall 13a″ is grounded to the first substrate 2a.

The first shell 50a″ includes an electrically conductive first coupler 14a that couples the first partition wall 12g and the first outer wall 13a″. The first coupler 14a is a plate-like member that intersects the line normal to the main surface of the first substrate 2a (straight line in the z1-axis direction). The first coupler 14a couples the first partition wall 12g and the first outer wall 13a″ on the side far from the first substrate 2a. Due to this, an annular (frame-like) protrusion is formed, by the first partition wall 12g, the first outer wall 13a″, and the first coupler 14a, that surrounds the first contact 10a. This annular protrusion functions as an electromagnetic shielding member between the first contact 10a and outside.

When viewing from the z1-axis direction, the third outer wall 13c″ is integrated with the first outer wall 13a″ and surrounds the first housing 11a″ on four sides. The third outer wall 13c″ is a portion that, when viewed from the z1-axis direction, surrounds the second holder 20b of the first housing 11a together with the first partition wall 12g. Note that the third outer wall 13c″ can be regarded as an electrically conductive member that connects a pair of the first outer walls 13a″ to each other.

An elastic contactor 18d is provided on the first partition wall 12g and the first outer wall 13a″. The elastic contactor 18d projects convexly from the wall main body, and is provided at one location at the center in the y1-axis direction.

As illustrated in FIGS. 26A and 26B, a stopper 16a is provided on the first outer wall 13a″, The stopper 16a protrudes convexly from the wall main body toward the outer periphery.

In the receptacle connector 1e, the first contact 10a and the second contact 10b are partitioned by the first partition wall 12g. Additionally, the first contact 10a is surrounded on four sides by the first outer wall 13a″ and the first partition wall 12g, and the second contact 10b is surrounded on four sides by the third outer wall 13c″ and the first partition wall 12g. In the receptacle connector 1e, the first partition wall 12g is arranged such that the first contact 10a cannot be seen from the second contact 10b.

### Plug Connector

Next, the configuration of the plug connector If is described. As illustrated in FIG. 25B, the plug connector If includes a third contact 10c that is an electrically conductive member, a fourth contact 10d that is an electrically conductive member, a second housing 11b″ that is an insulating member, a second partition wall 12h that is an electrically conductive member, a second outer wall 13b″ that is an electrically conductive member, and a fourth outer wall 13d″ that is an electrically conductive member.

The configurations, shapes, and arrangements of the third contact 10c and the fourth contact 10d are the same as the configurations, shapes, and arrangements of the third contact 10c and the fourth contact 10d of the receptacle connector 1a according to the embodiments described above. However, the sizes of the third contact 10c and the fourth contact 10d according to the present embodiment differ from those of the third contact 10c and the fourth contact 10d according to Embodiment 1. Specifically, the width in the x1-axis direction of the third contact 10c is smaller than that of the fourth contact 10d.

The second housing 11b″ includes a third holder 20c that holds the third contact 10c, and a fourth holder 20d that holds the fourth contact 10d. The fourth holder 20d is arranged at the center in the x2-axis direction, and the third holder 20c is arranged at each end in the x2-axis direction.

The second partition wall 12h is held by the second housing 11b″ so as to partition the third holder 20c and the fourth holder 20d. Since the third holder 20c is provided at both ends in the x2-axis direction of the fourth holder 20d, the second partition wall 12h is provided at each of both ends in the x2-axis direction of the fourth holder 20d. The two second partition walls 12h each extend in the y2-axis direction and partition the third holder 20c and the fourth holder 20d.

The plug connector If includes a second shell 50b″ that is a metal member and that, when viewing from the z2-axis direction, surrounds the second housing 11b″ on four sides. The second outer wall 13b″ and the fourth outer wall 13d″ are portions of the second shell 50b″. The second shell 50b″ has a size that contacts an outer peripheral portion of the first shell 50a″ of the receptacle connector 1a.

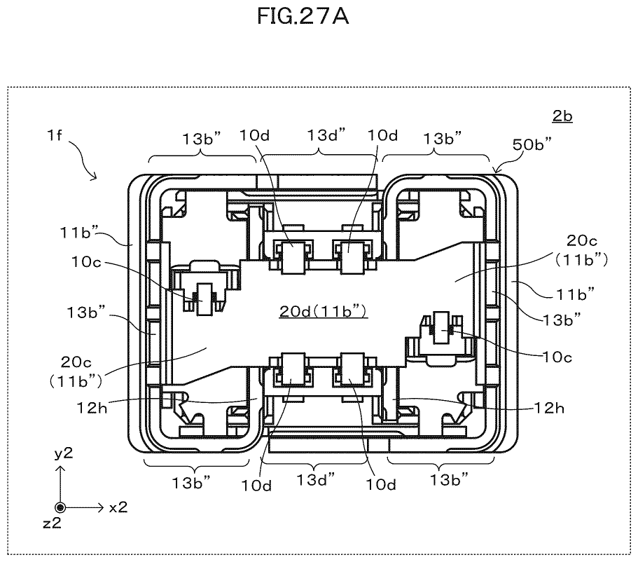

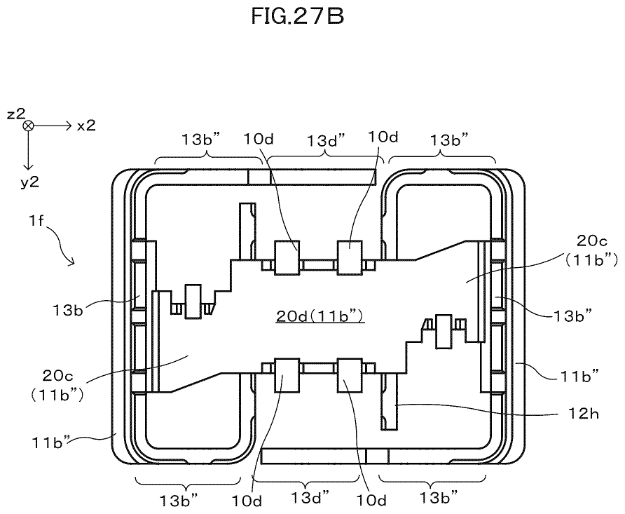

As illustrated in FIGS. 27A and 27B, the second outer wall 13b″ is a portion of the second shell 50b″ that, when viewed from the direction of the line normal to the main surface of the second substrate 2b, surrounds the third holder 20c together with the second partition wall 12h. More specifically, the second outer wall 13b″ includes an opposing wall that opposes the second partition wall 12h, and side walls that respectively extend from each end of the opposing wall toward the second partition wall 12h. The third contact 10c is surrounded by the opposing wall and the side walls, and the second partition wall 12h.

The second outer wall 13b″ is connected to the ground electrode 41 of the second substrate 2b. That is, the second outer wall 13b″ is grounded to the second substrate 2b. Additionally, when viewed from the z2-axis direction, the second outer wall 13b″ is arranged outward from an outer shape that includes the end of the substrate connector 21a of the third contact 10c. In the present embodiment, the entire third contact 10c is surrounded by ground members.

In the second shell 50b″, the second partition wall 12h and the second outer wall 13b″ are coupled. A recess is formed, by the second partition wall 12h and the second outer wall 13b″, that surrounds the third contact 10c. When the plug connector If and the receptacle connector 1e are fitted together, the annular protrusion, formed by the first partition wall 12g, the first outer wall 13a″, and the first coupler 14a of the receptacle connector 1e, is fitted into this recess.

A stopper 16b is provided on the second outer wall 13b″. The stopper 16b is recessed relative to the wall main body, and is provided at one location of the side wall, and two locations of the opposing wall.

As illustrated in FIGS. 27A and 27B, in the plug connector 1f, the third contact 10c and the fourth contact 10d are partitioned by the second partition wall 12h. Additionally, the third contact 10c is surrounded on four sides by the second outer wall 13b″ and the second partition wall 12h. In the plug connector lf, the second partition wall 12h is arranged such that the third contact 10c cannot be seen from the fourth contact 10d. In particular, the second partition wall 12h is arranged such that the substrate connector 21a of the third contact 10c cannot be seen from the substrate connector 21a of the fourth contact 10d.

Next, the operations of the electrical connector pair 1 according to the present embodiment are described.

The receptacle connector 1e and the plug connector If are made to face each other such that the +z1-axis direction and the +z2-axis direction are opposite directions. Furthermore, provided that the first shell 50a″ is configured to be accommodated in the inner periphery of the second shell 50b″, the positions of the annular (frame-like) protrusion formed by the first partition wall 12g, the first outer wall 13a″, and the first coupler 14a, and the recess formed by the second outer wall 12h and the second outer wall 13b″ match. Guiding by the protrusion and the recess makes it possible to fit the plug connector If and the receptacle connector 1e together.

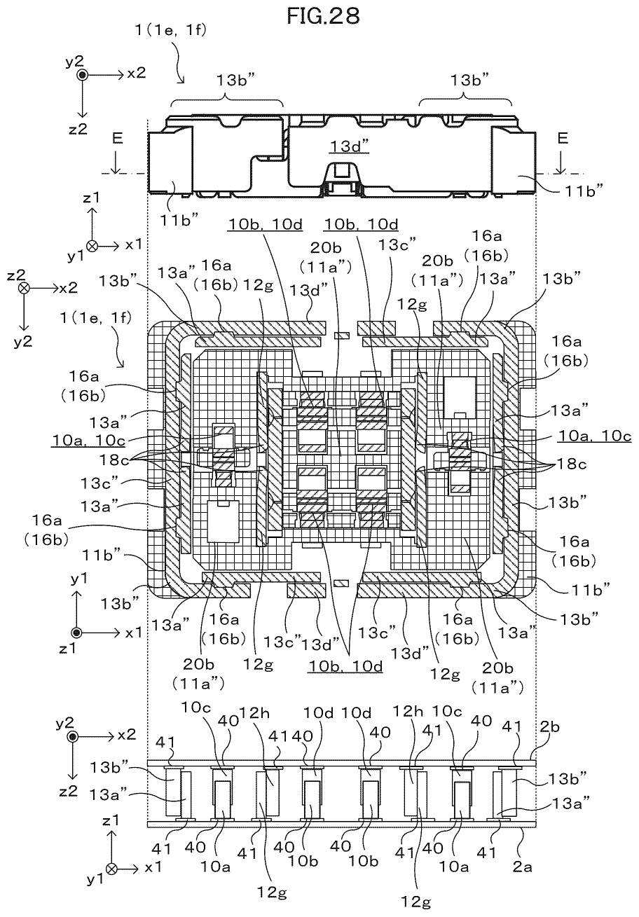

As illustrated in FIG. 28, when the receptacle connector 1e and the plug connector lf are fitted together, the stopper 16a and the stopper 16b engage. Additionally, the elastic contactor 18c presses against and contacts the second partition wall 12h and the third outer wall 13c″, and the elastic contactor 18d presses against and contacts the fourth outer wall 13d″. As a result, the fitting strength of receptacle connector 1e and the plug connector If can be enhanced.

Additionally, when the receptacle connector 1e and the plug connector If are fitted together, the first contact 10a and the third contact 10c contact. As a result, a signal transmission path, specifically, the signal electrode 40 of the first substrate 2a→the first contact 10a→the third contact 10c→the signal electrode 40 of the second substrate 2b is formed.

Additionally, when the receptacle connector 1e and the plug connector If are fitted together, as with the first contact 10a and the third contact 10c, the second contact 10b and the fourth contact 10d contact. As a result, a signal transmission path, specifically, the signal electrode 40 of the first substrate 2a→the second contact 10b→the fourth contact 10d→the signal electrode 40 of the second substrate 2b is formed.

Furthermore, when the receptacle connector 1e and the plug connector If are fitted together, the first partition wall 12g and the second partition wall 12h become adjacent in the x1-axis direction, and assume a contacting state. In this case, the second contact 10b and the fourth contact 10d, and the first contact 10a and the third contact 10c are doubly partitioned by the first partition wall 12g and the second partition wall 12h. Due to the first partition wall 12g and the second partition wall 12h, the first contact 10a and the third contact 10c cannot be seen from the second contact 10b and the fourth contact 10d. As a result, electromagnetic noise that is introduced to the second contact 10b and the fourth contact 10d from the first contact 10a and the third contact 10c can be reduced and, furthermore, leakage of electromagnetic noise from the second contact 10b and the fourth contact 10d to the first contact 10a and the third contact 10c can be further reduced.

As described in detail above, with the electrical connector pair 1 according to some embodiments described above, the receptacle connector 1a includes the electrically conductive first partition wall 12a that partitions the first contact 10a and the second contact 10b. Additionally, the plug connector 1b includes the electrically conductive second partition wall 12b that partitions the third contact 10c and the fourth contact 10d member. When the receptacle connector 1a and the plug connector 1b fitted together, the first partition wall 12a and the second partition wall 12b partition the first contact 10a and the third contact 10c, and the second contact 10b and the fourth contact 10d. Due to this configuration, the first partition wall 12a and the second partition wall 12b can reflect the electromagnetic noise generated by the second contact 10b and the fourth contact 10d, and the electromagnetic noise thereof can be prevented from becoming introduced into the electrical signals transmitted through the first contact 10a and the third contact 10c. As a result, the noise that is introduced into the transmission lines of the signal can be reduced.

Likewise, with the electrical connector pair 1 according to some embodiments described above, the first partition wall 12a and the second partition wall 12b can reflect the electromagnetic noise generated by the first contact 10a and the third contact 10c, and the electromagnetic noise thereof can be prevented from becoming mixed into the electrical signals transmitted through the second contact 10b and the fourth contact 10d.

In the receptacle connector 1a, the first contact 10a and the second contact 10b are partitioned by the first partition wall 12a, and electromagnetic noise from the second contact 10b is restricted from being introduced to the first contact 10a. In the present embodiment, the plug connector 1b also includes the second partition wall 12b that partitions the third contact 10c and the fourth contact 10d and, in the first partition wall 12a, the second partition wall 12b blocks a potion that could not be completely blocked, thereby further preventing the passage of electromagnetic noise and further suppressing the introduction of electromagnetic noise.

In the present embodiment, when the receptacle connector 1a and the plug connector 1b are fitted together, the first partition wall 12a partitions the portion of the boundary between the third holder 20c and the fourth holder 20d where the second partition wall 12b is not formed such that the first contact 10a and the third contact 10c cannot be seen from the second contact 10b and the fourth contact 10d. With such a configuration, the first partition wall 12a and the second partition wall 12b complement each other, and can block the electromagnetic waves that radiate from the second and fourth contacts 10b, 10d or the first and third contacts 10a, 10c. The first partition wall 12a and the second partition wall 12b need only partition a portion of the boundary between the first holder 20a and the second holder 20b, and the third holder 20c and the fourth holder 20d. As such, the degree of freedom related to the design of the first partition wall 12a and the second partition wall 12b can be enhanced. Additionally, in the plug connector 1b, the second partition wall 12b is not coupled to the second shell 50b and, as such, deflection of the second partition wall 12b due to stress transmitted from the second shell 50b is prevented. Furthermore, in the first partition wall 12a, the second partition wall 12b shields portions where shielding is difficult and, as such, electromagnetic shielding performance can be enhanced.

With the electrical connector pairs 1 according to Embodiments 1 to 5, the first partition wall 12a and the second partition wall 12b contact when fitted together. This configuration is adopted in order to increase electromagnetic shielding performance. However, it is not required that the first partition wall 12a and the second partition wall 12b contact when fitted together.

With the electrical connector pair 1 according to Embodiments 1 and 2, when the receptacle connector 1a and the plug connector 1b are fitted together, the first partition wall 12a and the second partition wall 12b are engaged by the stoppers 15a, 15b. As a result, the fitting force between the receptacle connector 1a and the plug connector 1b can be increased. This point is true for the electrical connector pair 1 according to Embodiments 4 and 5 as well.

With the electrical connector pair 1 according to Embodiments 1 and 2, when the receptacle connector 1a and the plug connector 1b are fitted together, both constituents are pressed on by the elastic contactors 18c, 18d and, thereby, contact. As a result, the fitting force between the receptacle connector 1a and the plug connector 1b can be increased. This point is true for the electrical connector pair 1 according to Embodiments 4 and 5 as well.

With the electrical connector pair 1 according to Embodiments 1 and 2, when the receptacle connector 1a and the plug connector 1b are fitted together, the second partition wall 12b is arranged so as to overlap the first partition wall 12a when viewed from the first contact 10a and the third contact 10c. Due to this configuration, the wall of the conductor is doubled, thereby making it possible to increase the electromagnetic noise shielding performance. This point is true for the electrical connector pair 1 according to Embodiments 4 and 5 as well.

According to Embodiments 1 and 2, the first partition wall 12a includes the first end 30a that contacts the first substrate 2a, and the first ground connector 31a that connects to the ground electrode 41 of the first substrate 2a is provided on the first end 30a. Due to this configuration, the electromagnetic noise component reflected by the first partition wall 12a can be quickly released from the first ground connector 31a. This point is true for the electrical connector pair 1 according to Embodiments 4 and 5 as well.

According to Embodiment 2, the second partition wall 12b includes the second end 30b that contacts the second substrate 2b, and the second ground connector 31b that connects to the ground electrode 41 of the second substrate 2b is provided on the second end 30b. Due to this configuration, the electromagnetic noise component reflected by the first partition wall 12a can be quickly released from the first ground connector 31a.

According to the embodiments described above, the receptacle connector 1a includes the electrically conductive first outer wall 13a that surrounds the first holder 20a together with the first partition wall 12a when viewed from the direction normal to the main surface of the first substrate 2a, and that connects to the ground electrode 41 of the first substrate 2a. Furthermore, the plug connector 1b includes the electrically conductive second outer wall 13b that surrounds the third holder 20c together with the second partition wall 12b when viewed from the direction normal to the main surface of the second substrate 2b, and that connects to the ground electrode 41 of the second substrate 2b. Due to this configuration, it is possible to prevent electromagnetic noise from being introduced to the first contact 10a and the third contact 10c from outside, and to prevent the leaking of electromagnetic noise from the first contact 10a and the third contact 10c to the outside. This point is true for the electrical connector pair 1 according to Embodiments 4 and 5 as well.

According to the embodiments described above, when the receptacle connector 1a and the plug connector 1b are fitted together, the first outer wall 13a and the second outer wall 13b are arranged doubly when viewing from the first contact 10a and the third contact 10c. Due to this configuration, the wall of the conductor is doubled, thereby making it possible to increase the electromagnetic noise shielding performance. This point is true for the electrical connector pair 1 according to Embodiments 4 and 5 as well.

With the electrical connector pair 1 according to Embodiments 1 to 3, when the receptacle connector 1a and the plug connector 1b are fitted together, the first outer wall 13a and the second outer wall 13b engage. As a result, the fitting force between the receptacle connector 1a and the plug connector 1b can be increased. This point is true for the electrical connector pair 1 according to Embodiments 4 and 5 as well.

According to the embodiments described above, the electrically conductive first coupler 14a that couples the first partition wall 12a and the first outer wall 13a is provided. Additionally, the electrically conductive second coupler 14b that couples the second partition wall 12b and the second outer wall 13b is provided. Coupling the partition walls and the outer walls in this manner enables the further enhancement of electromagnetic shielding performance.

In the embodiments described above, the first coupler 14a is a plate-like member that intersects the line normal to the main surface of the first substrate 2a, and the second coupler 14b is a plate-like member that intersects the line normal to the main surface of the second substrate 2b. Due to this configuration, the first coupler 14a and the second coupler 14b can be made to function as electromagnetic shielding members in the normal line directions of the main surfaces. Note that a configuration is possible in which an electrically conductive coupler that couples the first partition wall 12a and the third outer wall 13c is provided. Additionally, a configuration is possible in which an electrically conductive couple that couples the second partition wall 12b, and the second outer wall 13b or the fourth outer wall 13d is provided.

With the electrical connector pair 1 according to Embodiments 1 to 3, the annular protrusion that surrounds the first contact 10a is formed by the first partition wall 12a, the first outer wall 13a, and the first coupler 14a; and the recess that surrounds the second contact 10b, and into which the protrusion is fitted when the receptacle connector 1a and the plug connector 1b are fitted together is formed by the second partition wall 12b, the second outer wall 13b, and the second coupler 14b. Due to this configuration, the protrusion and the recess can be made to function as guide member when fitting the receptacle connector 1a and the plug connector 1b together. This point is true for the electrical connector pair 1 according to Embodiments 4 and 5 as well.

In the electrical connector pair 1 according to Embodiments 1 to 3, in the receptacle connector 1a, the pair of first outer walls 13a is coupled by the third outer wall 13c that is an electrically conductive member and, in the plug connector 1b, the pair of second outer walls 13b is coupled by the fourth outer wall 13d that is an electrically conductive member. Due to this configuration, the potential of the pair of first outer walls 13a is made the same and, as a result, the electric and magnetic field environments surrounding the signals flowing through the pairs of first contacts 10a and third contacts 10c can be made uniform. This point is true for the electrical connector pair 1 according to Embodiment 5 as well.

With the electrical connector pair 1 according to Embodiments 1 to 3, the receptacle connector 1a includes the electrically conductive third outer wall 13c that surrounds the second holder 20b together with the first partition wall 12a when viewed from the direction normal to the main surface of the first substrate 2a. Additionally, the plug connector 1b includes the electrically conductive fourth outer wall 13d that surrounds the fourth holder 20d together with the second partition wall 12b when viewed from the direction normal to the main surface of the second substrate 2b. Due to this configuration, it is possible to prevent electromagnetic noise from being introduced to the second contact 10b and the fourth contact 10d from outside, and to prevent the leaking of electromagnetic noise from the second contact 10b and the fourth contact 10d to the outside. This point is true for the electrical connector pair 1 according to Embodiment 5 as well.

With the electrical connector pair 1 according to Embodiments 1 to 3, when the receptacle connector 1a and the plug connector 1b are fitted together, the third outer wall 13c and the fourth outer wall 13d are arranged doubly when viewing from the second contact 10b and the fourth contact 10d. Due to this configuration, the wall of the conductor is doubled, thereby making it possible to increase the electromagnetic noise shielding performance. This point is true for the electrical connector pair 1 according to Embodiment 5 as well.

With the electrical connector pair 1 according to Embodiments 1 and 3, when the receptacle connector 1a and the plug connector 1b fitted together, the third outer wall 13c and the fourth outer wall 13d are engaged by the stoppers 16a, 16b. Due to this configuration, the fitting force between the receptacle connector 1a and the plug connector 1b can be increased. This point is true for the electrical connector pair 1 according to Embodiment 5 as well.

With the electrical connector pair 1 according to Embodiments 1 to 3, the first outer wall 13a and the third outer wall 13c are integrated, and the second outer wall 13b and the fourth outer wall 13d are integrated. Due to this configuration, the outer walls are coupled, thereby making it possible to enhance the electromagnetic noise shielding performance. This point is true for the electrical connector pair 1 according to Embodiment 5 as well.

With the electrical connector pair 1 according to Embodiments 1 to 3, in the receptacle connector 1a, the pair of first holders 20a is arranged so as to sandwich the second holder 20b and, in the plug connector 1b, the pair of third holders 20c is arranged so as to sandwich the fourth holder 20d. Due to this configuration, it is possible to shield the electromagnetic noise from one of the first contacts 10a and the third contact 10c to the other of the first contact 10a and the third contact 10c by the doubled first partition wall 12a and second partition wall 12b. Additionally, the space between one of the first contact 10a and the third contact 10c and the other of the first contact 10a and the third contact 10c is widened, and second contact 10b and the fourth contact 10d are arranged in that space. As a result, electromagnetic noise that affects the signals generated from the one of the first contact 10a and the third contact 10c and transmitted to the other of the first contact 10a and the third contact 10c can be minimized. This point is true for the electrical connector pair 1 according to Embodiments 4 and 5 as well.

In the embodiments described above, the shapes of the receptacle connectors 1a, 1c, 1e and the plug connectors 1b, 1b′, 1d, If are configured with the x1-axis direction and the x2-axis direction as the longitudinal direction, but the present disclosure is not limited thereto. A configuration is possible in which the y1-axis direction and the y2-axis direction are set as the longitudinal direction, or the overall shapes are square. Furthermore, a configuration is possible in which the shapes of the receptacle connector 1a and the plug connector 1b are not rectangular.

With the receptacle connector 1a and the plug connector 1b according to Embodiments 1 to 3, pairs of the first contact 10a and the third contact 10c are provided, and four of the second contact 10b and the fourth contact 10d are provided, but it is sufficient that these numbers be greater than or equal to one. This point is true for the electrical connector pair 1 according to Embodiments 4 and 5 as well.

In the embodiments described above, when viewing from the z1-axis and the z2-axis directions, the first contact 10a and the third contact 10c, and the second contact 10b and the fourth contact 10d are arranged in directions such that the x1-axis and x2-axis directions are the longitudinal direction, but the present disclosure is not limited thereto. The directions of the first contact 10a and the third contact 10c are not limited. This is true from the second contact 10b and the fourth contact 10d as well.

Shapes other than those described in the embodiments can be used for the shapes of the first contact 10a and the third contact 10c, and the second contact 10b and the fourth contact 10d. For example, a configuration is possible in which the shapes of the first contact 10a and the second contact 10b differ. This is true for the shapes of the third contact 10c and the fourth contact 10d as well.

A configuration is possible in which the frequency band of the signal to be transmitted, the current, the voltage, the use (for signal transmission or for grounding), and the like of the first contact 10a, 10a′ and the third contact 10c, 10c′, and the second contact 10b, 10b′ and the fourth contact 10d, 10d′ differ. For example, a configuration is possible in which the first contact 10a, 10a′ and the third contact 10c, 10c′ transmit a high-frequency signal, and the second contact 10b, 10b′ and the fourth contact 10d, 10d′ transmit a low-frequency signal.

The first contact 10a, 10a′ and the third contact 10c, 10c′, and the second contact 10b, 10b′ and the fourth contact 10d, 10d′ can be formed by punching, bending, or the like of one plate material from a metal thin plate. The substrate connector 21a, 21b may have any shape provided that connection to the signal electrode 40 is possible, and may have a shape that does not project outward.

The first housing 11a, 11a′ and the second housing 11b, 11b′ can be formed by injection molding of resin material. Alternatively, the first housing 11a, 11a′ and the second housing 11b, 11b′ can be formed by three-dimensional printing or other molding techniques.

In the embodiments described above, the first housing 11a, 11a′ includes a pair of the first holder 20a and one of the second holder 20b, but the present disclosure is not limited thereto. A configuration is possible in which one each of the first holder 20a and the second holder 20b is provided. Thus, the number and arrangement of the first holder 20a and the number and arrangement of the second holder 20b are not limited. For example, a configuration is possible in which a pair of the second holder 20b sandwiches the first holder 20a. In any case, in the electrical connector pair 1, the third holder 20c opposes the first holder 20a and the fourth holder 20d opposes the second holder 20b.

In one example, the first shell 50a, 50a′, 50a″ and the second shell 50b, 50b′, 50b″ are formed by punching a single layer plate material from a metal thin plate, and bending the obtained plate material. However, the present disclosure is not limited thereto. A configuration is possible in which two or more plate materials are combined to form the first shell 50a, 50a′, 50a″ and the second shell 50b, 50b′, 50b″. The first shell 50a, 50a′, 50a″ and the second shell 50b, 50b′, 50b″ are fixed to the first housing 11a and the second housing 11b by press-fitting.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2019-222381, filed on Dec. 9, 2019, the entire disclosure of which is incorporated by reference herein.

### INDUSTRIAL APPLICABILITY

The present disclosure can be applied to electrical connectors that connect substrates. For example, the present disclosure can be applied to a device or the like that is used to connect circuit boards in an electronic device. Specific examples of the electronic device include portable communication terminals such as mobile phones, smartphones, laptop computers, and tablet computers, but are not limited thereto.

### REFERENCE SIGNS LIST

1 Electrical connector pair
1a, 1c, 1e Receptacle connector
1b, 1b′, 1d, lf Plug connector
2a First substrate
2b Second substrate
10a, 10a′ First contact
10b, 10b′ Second contact
10c, 10c′ Third contact
10d, 10d′ Fourth contact
11a, 11a′, 11a″ First housing
11b, 11b′, 11b″ Second housing
12a, 12a′, 12c, 12e, 12g First partition wall
12b, 12b′, 12d, 12f, 12h Second partition wall
13a, 13a′, 13a″ First outer wall
13b, 13b′, 13b″ Second outer wall
13c, 13c′, 13c″ Third outer wall
13d, 13d″ Fourth outer wall
14a First coupler
14b Second coupler
15a, 15b, 15c, 15d Stopper
16a, 16b Stopper
17a, 17b Stopper
18a, 18b, 18c, 18d Elastic contactor
20a First holder
20b Second holder
20c Third holder
20d Fourth holder
21a, 21b Substrate connector
22a, 22b Rising portion
23a, 23b Contact contactor
24a Protrusion
24b Recess
30a First end
30b Second end
31a, 31a′ First ground connector
31b Second ground connector
40 Signal electrode
41 Ground electrode
50a, 50a′, 50a″ First shell
50b, 50b′, 50b″ Second shell

1. An electrical connector pair comprising:
a first connector mounted on a first substrate; and
a second connector mounted on a second substrate, wherein
the first connector includes
an electrically conductive first contact that connects to a signal electrode of the first substrate,
an electrically conductive second contact that connects to the signal electrode of the first substrate,
an electrically conductive first periphery surrounding wall that, when viewed from a direction normal to a main surface of the first substrate, is arranged so as to surround the first contact and the second contact, and that connects to a ground electrode of the first substrate,
an insulating first housing that includes a first holder that insulates and holds the first contact and the first periphery surrounding wall, and a second holder that insulates and holds the second contact and the first periphery surrounding wall, and
a first conductive member that extends along a boundary between the first holder and the second holder in a state insulated from the first contact and the second contact to couple to a pair of walls of the first periphery surrounding wall at two ends of the boundary, that is held by the first housing, and that is grounded to the first substrate,
the second connector includes
an electrically conductive third contact that connects to a signal electrode of the second substrate, and that contacts the first contact when the first connector and the second connector are fitted together,
an electrically conductive fourth contact that connects to the signal electrode of the second substrate, and that contacts the second contact when the first connector and the second connector are fitted together,
an electrically conductive second periphery surrounding wall that, when viewed from a direction normal to a main surface of the second substrate, is arranged so as to surround the third contact and the fourth contact, and that connects to a ground electrode of the second substrate,
an insulating second housing that includes a third holder that insulates and holds the third contact and the second periphery surrounding wall, and a fourth holder that insulates and holds the fourth contact and the second periphery surrounding wall, and
a second conductive member that is held by the second housing so as to partition a portion of a boundary between the third holder and the fourth holder in a state insulated from the third contact and the fourth contact, and that is grounded to the second substrate, and
when the first connector and the second connector are fitted together, the first conductive member partitions a portion of boundary between the third holder and the fourth holder where the second conductive member is not formed.

2. The electrical connector pair according to claim 1, wherein
the first conductive member includes a first end that contacts the first substrate, and
a first ground connector that connects to the ground electrode of the first substrate is provided on the first end.

3. The electrical connector pair according to claim 1, wherein
the second conductive member includes a second end that contacts the second substrate, and
a second ground connector that connects to the ground electrode of the second substrate is provided on the second end.

4. The electrical connector pair according to claim 1, wherein
in the first connector, the first conductive member is arranged such that the first contact cannot be seen from the second contact, and
in the second connector, the second conductive member is arranged such that the third contact cannot be seen from the fourth contact.

5. The electrical connector pair according to claim 1, wherein
the first conductive member and the second conductive member contact each other when the first connector and the second connector are fitted together.

6. The electrical connector pair according to claim 5, wherein
the first conductive member and the second conductive member engage with each other when the first connector and the second connector are fitted together.

7. The electrical connector pair according to claim 1, wherein
when the first connector and the second connector are fitted together, the second conductive member is arranged so as to overlap the first conductive member when viewing from the first contact and the third contact.

8. The electrical connector pair according to claim 1, wherein
when the first connector and the second connector are fitted together, the first, second, third, and fourth contacts are doubly surrounded by the first periphery surrounding wall and the second periphery surrounding wall.

9. The electrical connector pair according to claim 1, wherein
the first periphery surrounding wall and the second periphery surrounding wall engage with each other when the first connector and the second connector are fitted together.

10. The electrical connector pair according to claim 1, wherein
an electrically conductive first coupler is provided that couples the first conductive member and the first periphery surrounding wall, and
an electrically conductive second coupler is provided that couples the second conductive member and the second periphery surrounding wall.

11. The electrical connector pair according to claim 10, wherein
the first coupler is a plate-like member that intersects a line normal to the main surface of the first substrate, and
the second coupler is a plate-like member that intersects a line normal to the main surface of the second substrate.

12. The electrical connector pair according to claim 11, wherein
an annular protrusion is formed, by the first conductive member, the first periphery surrounding wall, and the first coupler, that surrounds the first contact, and
a recess is formed, by the second conductive member, the second periphery surrounding wall, and the second coupler, that surrounds the second contact, and into which the protrusion fits when the first connector and the second connector are fitted together.

13. The electrical connector pair according to claim 1, wherein
in the first connector, a pair of the first holder is arranged so as to sandwich the second holder, and
in the second connector, a pair of the third holder is arranged so as to sandwich the fourth holder.
